(19) United States
(12) Patent Application Publication
(10) Pub. No.: US 2026/0289638 A1
(43) Pub. Date: Sep. 24, 2026

(54) SYSTEM

(71) Applicant: SoftBank Group Corp., Tokyo (JP)

(72) Inventor: Ryosuke OHTA, Tokyo (JP)

(73) Assignee: SoftBank Group Corp., Tokyo (JP)

(21) Appl. No.: 19/567,386

(22) Filed: Mar. 16, 2026

(30) Foreign Application Priority Data
Mar. 19, 2025 (JP) 2025-044975

(51) Int. Cl. G06Q 30/0601; G06F 16/338; G06F 21/10; G06F 40/30; G06Q 20/22

(52) U.S. Cl. CPC G06Q 30/0631; G06F 16/338; G06F 21/1014; G06F 40/30; G06Q 20/22

(57) ABSTRACT

A system includes a processor that is configured to receive, from a user, a prompt sentence as input, input the prompt sentence into a generative artificial intelligence model, cause the generative artificial intelligence model to generate at least one concept or design based on the prompt sentence, upload the generated concept or design to an electronic marketplace, and assign a non-fungible token to the generated concept or design.

### CROSS-REFERENCE TO RELATED APPLICATION

This application is based on and claims priority under 35 USC 119 from Japanese Patent Application No. 2025-044975 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, generative artificial intelligence models have become capable of automatically producing various types of content, such as conceptual ideas and designs, based on user-provided prompts. However, conventional systems do not provide an integrated mechanism that (i) accepts a user prompt, (ii) generates a concept or design via a generative artificial intelligence model, (iii) seamlessly registers and exposes the generated result on an electronic marketplace, and (iv) securely assigns unique digital ownership to the generated result. As a consequence, users face multiple problems, including a fragmented workflow across different services, difficulty in commercializing generated concepts or designs, and a lack of a reliable way to prove uniqueness and ownership of such generated content. Furthermore, conventional electronic marketplaces do not natively support automatic mediation of transactions involving generative artificial intelligence outputs, nor do they consistently calculate and record transaction fees as revenue for the marketplace operator. Accordingly, there is a need for a system that integrates generative artificial intelligence, an electronic marketplace, and non-fungible token assignment, while also supporting mediation of user-to-user transactions and fee management, in a unified and automated manner.

### SUMMARY

To solve the above-described problems, the present invention provides a system comprising a processor, wherein the processor is configured to receive, from a user, a prompt sentence as input and input the prompt sentence into a generative artificial intelligence model. The processor is further configured to cause the generative artificial intelligence model to generate at least one concept or design based on the prompt sentence and to upload the generated concept or design to an electronic marketplace. The processor is also configured to assign a non-fungible token to the generated concept or design so that the generated concept or design is uniquely identifiable and digitally ownable on a distributed ledger or equivalent infrastructure. In some embodiments, the processor is configured to analyze the prompt sentence by using a natural language processing technique and to instruct the generative artificial intelligence model to generate the concept or the design based on a result of the analysis, thereby improving the relevance and quality of the generated output. In further embodiments, the processor is configured to mediate a transaction between users with respect to the generated concept or design, calculate a fee based on the transaction, and record the fee as revenue, thereby enabling automated commercialization and fee management for concepts and designs generated via the generative artificial intelligence model and registered on the electronic marketplace.

The term “processor” refers to one or more hardware circuits, processing units, or computing devices, such as a central processing unit (CPU), a graphics processing unit (GPU), a microcontroller, or a combination thereof, that execute instructions to perform the functions described in the present specification and claims.

The term “prompt sentence” refers to a text input, including one or more words, phrases, sentences, or paragraphs, provided by a user to express requirements, constraints, or ideas that are used as a basis for content generation by a generative artificial intelligence model.
The term “generative artificial intelligence model” refers to a machine learning model, such as a neural network or a large language model, that is configured to produce new content, including concepts or designs, based on input data such as a prompt sentence.
The term “concept” refers to an abstract or concrete idea, plan, or proposal, including but not limited to product concepts, business concepts, branding concepts, or functional specifications, that is generated by the generative artificial intelligence model based on the prompt sentence.
The term “design” refers to a representation of an appearance, structure, layout, or style, including but not limited to graphic designs, user interface designs, logo designs, and product designs, that is generated by the generative artificial intelligence model based on the prompt sentence.
The term “electronic marketplace” refers to an online platform, server system, or electronic commerce environment that is configured to register, list, display, and facilitate transactions for digital or non-digital items, including the generated concepts or designs.
The term “upload” refers to the operation of transmitting or registering data representing the generated concept or design from the processor to the electronic marketplace so that the generated concept or design becomes storable, searchable, displayable, or tradable on the electronic marketplace.
The term “non-fungible token” refers to a unique digital token recorded on a distributed ledger or equivalent infrastructure, the token being configured to represent a unique association with a specific generated concept or design so as to distinguish it from other assets and to indicate digital ownership or provenance.
The term “assign a non-fungible token” refers to an operation in which the processor causes a non-fungible token to be created, associated, or linked with a particular generated concept or design, such that the non-fungible token uniquely identifies the generated concept or design and can be used to manage ownership or transfer thereof.
The term “natural language processing technique” refers to any algorithm, model, or method for analyzing, interpreting, or transforming human language text, including but not limited to tokenization, parsing, semantic analysis, intent detection, and embedding generation, used to process the prompt sentence.
The term “mediate a transaction” refers to the operation in which the processor coordinates or manages a buying or selling process between at least two users, including steps such as receiving purchase requests, verifying item availability, interacting with payment services, updating ownership records, and confirming completion of the transaction.
The term “fee” refers to a monetary amount calculated by the processor based on at least one parameter of a transaction, such as a sale price, and allocated as compensation, commission, or service charge for operation of the electronic marketplace.
The term “record the fee as revenue” refers to the operation in which the processor stores, in a memory or database, information indicating the amount of the fee and its attribution as income or earnings for an operator of the system or electronic marketplace.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

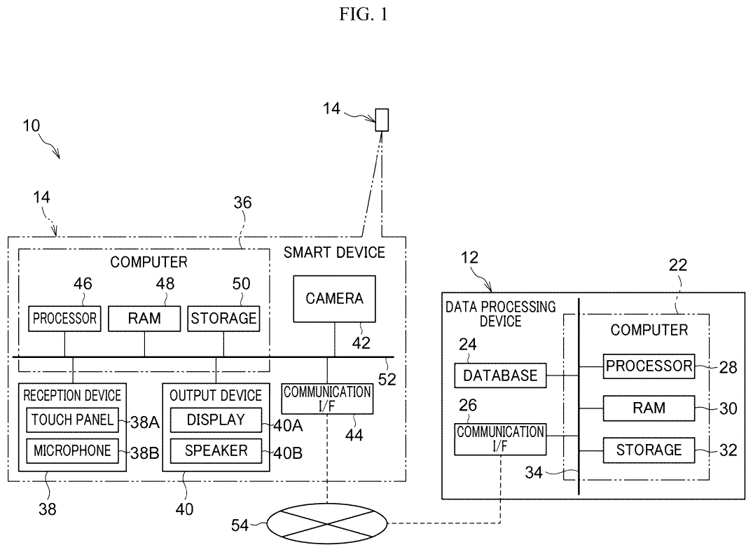

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

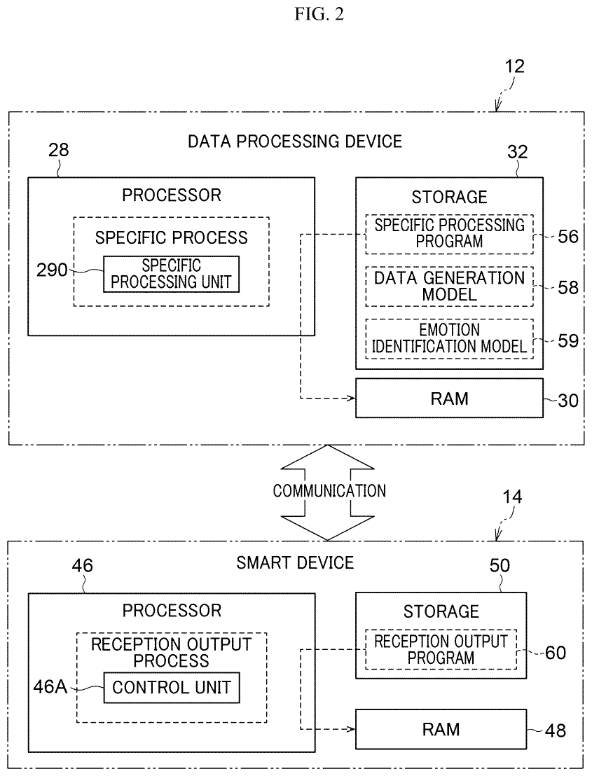

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional electronic marketplaces for digital content, including concepts and designs generated with a generative AI model, suffer from several technical limitations in their server-side processing and data management architectures. In many existing systems, a prompt sentence input by a user is treated as simple free-form text and is passed through to an external AI service without structured preprocessing, model-specific optimization, or unified token-level control. As a result, server resources are used inefficiently, output quality is unstable, and the server cannot systematically align model behavior with marketplace requirements such as categorization, pricing, and rights management.

Furthermore, conventional systems generally handle the generative AI model, the electronic marketplace, and the distributed ledger for non-fungible tokens as loosely coupled and manually bridged components. The server often does not maintain an integrated association between: (i) the prompt sentence and user information; (ii) the generation result data from the generative AI model; (iii) structured sales information used for listing; and (iv) non-fungible token ownership data on a distributed ledger. This fragmented architecture leads to technical problems such as redundant data processing, inconsistent state between marketplace databases and ledger records, and complex error handling when transactions fail or partially complete.
In addition, typical marketplaces calculate fees and record revenue using application-layer business logic that is not tightly bound to the underlying data structures governing generated content and tokenized ownership. The server does not provide a unified, machine-managed flow in which generation, listing, token issuance, purchase, fee calculation, and ownership transfer are orchestrated as a single, coherent transaction pipeline. This lack of integration causes performance overhead in coordinating multiple subsystems, increases the likelihood of race conditions and inconsistent transaction history, and complicates scalable search, ranking, and retrieval of AI-generated content tied to tokenized ownership information.
Moreover, existing search and browsing mechanisms in such marketplaces generally treat generated content, listing metadata, and transaction history as separate indices. The server often cannot effectively correlate the original prompt sentence or user search conditions with the internal representation of generated concepts or designs and with related ownership and transaction history data. As a result, search accuracy and ranking quality are degraded, and the system cannot efficiently provide a technically optimized discovery experience for AI-generated assets.
Accordingly, there is a need for an improved server architecture and processing method that: (i) converts prompt sentences into a model-ready representation through structured natural language processing; (ii) tightly integrates generative AI model execution with marketplace listing creation and non-fungible token issuance; (iii) manages purchase transactions, fee calculation, and revenue recording in a unified data model; and (iv) supports efficient search and ranking over correlated listing information, generation result data, and distributed-ledger-based ownership information. Such an architecture should provide improved consistency, reliability, and performance of the computer system itself, rather than merely automating manual marketplace operations.

The specific processing by the specific processing unit 290 of the data processing device 12 in Example 1 is realized by the following means.

The present invention provides a server comprising a processor configured to receive, via a communication network, a prompt sentence from a user terminal and generate generation request data including the prompt sentence and user information; convert the prompt sentence included in the generation request data into an input format for a generative AI model by performing tokenization processing and length control processing based on natural language processing; execute the generative AI model using an information processing apparatus to generate, by computation based on the converted prompt sentence, generation result data including description data of a concept or design; generate, based on the generation result data, sales information including explanation information, attribute information, and price information as structured data, and register the structured data as listing information of an electronic marketplace; generate, in association with the sales information, an issuance transaction of a non-fungible token based on distributed ledger technology, and record identification information and owner information of the non-fungible token in association with the listing information; transmit, in response to a viewing request from another user terminal, the listing information, the generation result data, and ownership information of the non-fungible token to cause the other user terminal to display the listing information, the generation result data, and the ownership information; receive purchase and sale requests between users in the electronic marketplace, establish a purchase and sale transaction in cooperation with a payment processing apparatus, calculate a fee based on the purchase and sale transaction, and record the fee as revenue information; and execute, in response to establishment of the purchase and sale transaction, an ownership transfer transaction of the non-fungible token by the distributed ledger technology and update the listing information and transaction history information based on a result of the ownership transfer. This enables the computer system to implement an integrated, technically optimized pipeline from prompt sentence processing through generative AI execution, marketplace listing, tokenized ownership management, and transaction processing, thereby improving consistency, reliability, and performance of server-side operations in handling AI-generated concepts and designs.

The term “prompt sentence” refers to character data input by a user via a user terminal, the character data expressing, in a natural language, a request, condition, or constraint for generation of a concept or design by a generative AI model.

The term “user terminal” refers to an information processing apparatus operated by a user and configured to communicate with a server via a communication network, the information processing apparatus including, for example, a computing device having an input unit, a display unit, and a communication unit.

The term “communication network” refers to a data transmission infrastructure that enables exchange of digital information between the server and one or more user terminals, the data transmission infrastructure including, for example, a packet-switched network such as the Internet or a wireless communication network.

The term “generation request data” refers to structured data generated by the server based on a prompt sentence received from a user terminal, the structured data including at least the prompt sentence and user-related information, and being configured as input for subsequent processing by a generative AI model.

The term “user information” refers to data that identifies or characterizes a user, including, for example, an account identifier, authentication information, preference information, or usage history, and that is associated with a prompt sentence or generated content.

The term “generative AI model” refers to a trained information processing model that receives an input representing a prompt sentence and outputs generated data such as a concept or design, the trained information processing model including, for example, a machine learning model utilizing parameters optimized by training on sample data.

The term “tokenization processing” refers to processing that converts a prompt sentence or other text data into a series of tokens or token identifiers suitable as input to a generative AI model, the processing including, for example, segmentation of text into subword units or symbols.

The term “length control processing” refers to processing that adjusts a length of a token sequence representing a prompt sentence, the processing including, for example, truncation, padding, or segmentation to conform to constraints of a generative AI model.

The term “natural language processing” refers to a category of data processing techniques in which text expressed in a natural language is analyzed or transformed by a computer, the techniques including, for example, morphological analysis, syntactic analysis, and semantic analysis.

The term “information processing apparatus” refers to a hardware platform including at least one processor and at least one memory device, the hardware platform being configured to execute program instructions that implement a generative AI model or related processing.

The term “generation result data” refers to data output from a generative AI model based on a converted prompt sentence, the data including at least description data representing a concept or design generated by computation of the generative AI model.

The term “description data of a concept or design” refers to digital information that expresses characteristics, structure, features, or appearance of a generated concept or design in a machine-readable form, the digital information including, for example, text data, attribute data, or references to media data.

The term “sales information” refers to structured data generated by the server for listing a generated concept or design in an electronic marketplace, the structured data including at least explanation information, attribute information, and price information.

The term “explanation information” refers to data that describes a generated concept or design in a human-readable manner, including, for example, a title, a summary, or a detailed description.

The term “attribute information” refers to metadata that characterizes a generated concept or design, the metadata including, for example, category information, tag information, usage conditions, or format information.

The term “price information” refers to data indicating a monetary value or consideration associated with a generated concept or design, the data including, for example, a listing price, a currency type, or pricing conditions.

The term “structured data” refers to data organized according to a predefined schema or format that defines fields and relationships, the data being storable and processable by a database management system.

The term “electronic marketplace” refers to an information processing platform that manages listing, browsing, and trading of digital content such as concepts and designs via a communication network, the information processing platform including a server-side component and an interface for user terminals.

The term “listing information” refers to data managed in the electronic marketplace that defines a unit of content available for viewing or purchase, the data including at least sales information and identifiers linking the content to a creator and, when applicable, to a non-fungible token.

The term “non-fungible token” refers to a digital token recorded on a distributed ledger, the digital token uniquely representing ownership or rights related to specific digital content, and being distinguishable from other tokens.

The term “distributed ledger technology” refers to a data management technology in which transaction data is replicated and synchronized across multiple computing nodes in a network, and in which updates to the data are validated according to a consensus mechanism.

The term “issuance transaction” refers to a transaction processed by a distributed ledger that causes creation or minting of a non-fungible token and registration of identification information and owner information of the non-fungible token.

The term “identification information of the non-fungible token” refers to data that uniquely identifies a non-fungible token within a distributed ledger system, the data including, for example, a token identifier or contract-related identifier.

The term “owner information of the non-fungible token” refers to data that indicates an entity recorded as holder of rights to a non-fungible token in a distributed ledger, the data including, for example, an account identifier or address on the distributed ledger.

The term “viewing request” refers to a request transmitted from a user terminal to the server to obtain listing information, generation result data, or ownership information for display on the user terminal.

The term “ownership information of the non-fungible token” refers to data indicating a current ownership state of a non-fungible token, including at least owner information and, optionally, history of ownership changes.

The term “purchase and sale request” refers to a request transmitted between a user terminal and the server, the request expressing an intention to purchase or sell a listed concept or design in the electronic marketplace.

The term “payment processing apparatus” refers to an information processing component or external service that performs authorization, settlement, and confirmation of financial transactions associated with purchase and sale requests.

The term “purchase and sale transaction” refers to a transaction in which a buyer and a seller agree, via the electronic marketplace, to exchange rights related to a concept or design for a consideration, and in which the transaction is processed by the server and the payment processing apparatus.

The term “fee” refers to monetary data representing compensation to the operator of the electronic marketplace, the compensation being calculated based on a purchase and sale transaction.

The term “revenue information” refers to data recorded by the server that indicates one or more fees or other income amounts obtained from purchase and sale transactions in the electronic marketplace.

The term “ownership transfer transaction” refers to a transaction processed by a distributed ledger that changes recorded ownership of a non-fungible token from a first owner to a second owner.

The term “transaction history information” refers to data stored by the server that records past events related to listing, purchase, sale, and ownership transfer of concepts, designs, or associated non-fungible tokens.

The term “candidate concepts or designs” refers to multiple alternative outputs generated by a generative AI model based on a prompt sentence, each alternative representing a different concept or design.

The term “selection operation” refers to an operation performed by a user via a user terminal to select at least one candidate concept or design from among multiple candidates, the operation including, for example, clicking, tapping, or other user interface actions.

The term “search processing” refers to processing in which the server retrieves listing information or transaction history information that matches one or more conditions derived from a prompt sentence or search conditions input by a user.

The term “ranking processing” refers to processing in which the server orders retrieved items, such as listing information, based on one or more evaluation criteria, including, for example, relevance, popularity, price, or recency.

The term “list information” refers to data representing a collection of multiple concepts or designs, the data including at least identification information and summary information for each item for display as a list on a user terminal.

In an embodiment, a server cooperates with one or more terminals operated by users to implement an integrated electronic marketplace for concepts and designs generated by a generative AI model. The server executes computer programs stored in a memory by using at least one processor. The server controls a data flow that begins with a prompt sentence entered at a terminal, passes through natural language based preprocessing and generative model execution, and continues through listing registration, non-fungible token issuance on a distributed ledger, and transaction management including fee calculation and ownership transfer.

In an embodiment, the server is implemented on an information processing apparatus including a central processing unit, a graphics processing unit, a main memory, a non-volatile storage device, and a network interface. The server uses a general-purpose operating system and a server-side framework to implement web services and application logic. For example, the server uses a web framework to provide an HTTP-based application programming interface, and uses a model execution library such as a tensor computation framework to execute the generative AI model on the graphics processing unit. The server uses a database management system, such as a relational database, to store structured data including generation request data, generation result data, sales information, listing information, and transaction history information. The server uses an object storage system to store large binary data such as image files and links the stored objects to structured metadata in the database. In an embodiment, the terminal is implemented as a computing device including a processor, a memory, a display, an input device, and a network interface. The terminal uses a web browser or a dedicated application to communicate with the server via a communication network. The terminal renders user interfaces in which a user inputs a prompt sentence, reviews generated concepts or designs, and initiates marketplace actions such as publishing and purchasing. The terminal performs local input validation, display layout computation, and state management, but the primary generative processing and marketplace state management reside on the server.

In an embodiment, the server uses a transformer-based generative AI model as the generative AI model. The server stores learned parameters of the model in a model file and loads the parameters into the graphics processing unit memory when initializing the system. The server uses a tokenizer component that maps Unicode text symbols to integer token identifiers based on a subword vocabulary. The server uses attention layers, feed-forward layers, positional encodings, normalization layers, and non-linear activation functions to compute outputs of the generative AI model. The server controls hyperparameters such as a number of layers, a number of attention heads, and a hidden state dimension. The server performs inference by repeatedly computing attention-based weighted sums of token embeddings, applying linear transformations, and using probability distributions over vocabulary tokens.

In an embodiment, the server trains the generative AI model in advance on a training dataset including text examples of concepts and designs, as well as associated metadata. The server uses a training procedure that minimizes a loss function such as cross-entropy between predicted token distributions and ground-truth tokens. The server updates model parameters using an optimization algorithm such as stochastic gradient descent or a variant thereof. The server optionally applies data augmentation techniques, such as paraphrasing or controlled noise injection into prompts and outputs, to increase training diversity. The server thus prepares a generative AI model that is specialized for generating design-oriented descriptions and structured attributes from prompt sentences.

In an embodiment, the server does not merely pass complete prompt sentences directly to an external model; instead, the server applies defined tokenization processing and length control processing before model execution. The server converts each prompt sentence into a token sequence using a tokenizer that operates according to a pre-defined vocabulary. The server then applies length control, such as truncation or padding, according to a maximum context length of the generative AI model. The server may perform a segmentation process if a prompt sentence is longer than an upper threshold, in which the server divides the sentence into segments, applies per-segment processing, and recombines model outputs. By managing input length explicitly, the server maintains stable model performance and prevents resource overuse, improving computation efficiency and response latency.

In an embodiment, the server further applies natural language processing techniques to enrich or normalize the prompt sentence before tokenization. The server may perform morphological analysis, part-of-speech tagging, and syntactic parsing to extract key terms and constraints. The server may perform normalization such as lowercasing, synonym mapping, and removal of extraneous tokens. The server may construct an intermediate representation that highlights essential constraints (for example, “futuristic”, “smartwatch”, “curved display”, “health tracking”) and passes this representation as structured tokens, which are concatenated with original text tokens as a composite input sequence. This dual representation improves the model's ability to focus attention on relevant features, thereby increasing precision and consistency of generated designs.

In an embodiment, the server controls the generative AI model to output not only free-form natural language text, but also structured segments that correspond to predefined fields. The server uses control tokens or embedded tags that instruct the model to emit sections such as “Title:”, “Overview:”, “Features:”, “Materials:”, and “Usage Scenarios:”. The server then parses model output by detecting these tags and stores the results into a structured data object such as a JSON-like data structure. This structured data forms part of the generation result data and is later used to populate sales information, listing information, and search indices. Because the server enforces a consistent structural template on model outputs, the server can store and retrieve content with improved indexing efficiency and search accuracy.

In an embodiment, the server further controls additional generative models such as an image generation model. The server derives an image prompt from the description data of a concept or design, for example, by extracting salient visual descriptors from the generation result data. The server then passes the image prompt to a diffusion-based image model deployed on a graphics processing unit. The server iteratively updates a latent representation using a noise schedule and applies a neural decoder to obtain pixel values. The server encodes the resulting image as an image file and stores the file in object storage. This process is not limited to simple text-to-image conversion; it is optimized for design content by selecting features that align with design relevance metrics.

In an embodiment, the following prompt sentences are examples that the user inputs at the terminal:

“Please generate a futuristic smartwatch design with a curved display and health-tracking sensors.”

“Create three minimalist logo design concepts for a sustainable fashion brand named ‘GreenRipple’.”

“Generate an interior layout concept for a compact home office that maximizes natural light and storage efficiency.”

“Please generate a more minimalistic smartwatch design with a thin metal band and a monochrome interface.”

The server treats these prompt sentences as inputs to the described tokenization and natural-language-based preprocessing and then to the generative AI model and subsequent processing pipeline.

In an embodiment, the server composes generation request data by combining the prompt sentence with user information and context information, such as a user identifier, a language preference, and historical preferences. The server stores this generation request data in the database and assigns it a unique identifier. The server uses this identifier thereafter to link generation result data, listing information, and non-fungible token data. By maintaining explicit identifiers and relations, the server improves data integrity and allows efficient joins and queries when the server later computes search results or transaction histories.

In an embodiment, the server relies on a defined data schema for generation result data and sales information. The server defines fields such as “concept id”, “prompt id”, “title”, “short description”, “detailed_description”, “feature_list”, “category”, “tag_list”, “price”, “licensing_terms”, and “media_reference”. The server maps each segment of the generative AI model output to one or more of these fields and performs automatic normalization, such as trimming white spaces, validating numeric ranges, and assigning default values when necessary. This detailed structuring goes beyond a simple textual storage; it enables indexing by individual fields, composite queries, and machine-level enforcement of constraints, which collectively enhances data management within the system.

In an embodiment, the server uses a database index over fields such as category, tag list, and price and additionally maintains a full-text index over textual fields such as title and descriptions. The server utilizes these indices when performing search and ranking processing. The server computes relevance scores using combinations of keyword matching, semantic similarity derived from vector embeddings, and marketplace metrics such as number of views and purchases. The server stores vector embeddings representing concepts and designs using dense vector indices, enabling fast approximate nearest neighbor search. The server thus upgrades standard database operations with specialized structures, producing improved performance in retrieving and ranking AI-generated content.

In an embodiment, the server directly interfaces with a distributed ledger network to manage non-fungible tokens representing ownership of concepts and designs. The server generates an issuance transaction by constructing a serialized transaction message that invokes a token contract. The server embeds in the transaction a token identifier, a reference to content metadata, and an initial owner address derived from user information. The server signs the transaction using a cryptographic module that manages private keys. The server submits the transaction to ledger nodes over a network connection and monitors the ledger until it detects confirmation. The server then records the confirmed token identifier, contract address, and transaction hash in the database, associating these with the corresponding listing information. In an embodiment, the server also generates and executes ownership transfer transactions. When a purchase and sale transaction is successfully completed, the server constructs another ledger transaction that modifies the owner field of the non-fungible token. The server signs and submits this transaction, waits for confirmation, and then updates ownership information in the database. Because the server coordinates marketplace transaction records and distributed ledger transactions through shared identifiers and transaction hashes, the server maintains consistency between off-chain data structures and on-chain ownership data, reducing mismatches and enabling auditability.

In an embodiment, the server implements a unified transaction management module that coordinates internal operations related to listing creation, token issuance, purchase recording, fee calculation, and ownership transfer. The server bundles logically related operations into atomic units where possible, using database transactions that guarantee either full commit or full rollback. The server orchestrates external ledger and payment service calls using a state machine pattern, where each state transition is explicitly recorded and can be retried or rolled back depending on outcomes. This architecture reduces race conditions and inconsistent intermediate states and improves reliability and resilience of the system as a whole.

In an embodiment, the server calculates fees using deterministic arithmetic operations based on stored pricing rules and transaction values. The server computes, for example, a service fee as a predetermined percentage of a listing price, applies tax rules when applicable, and stores intermediate and final results in revenue information records. The server separates fee records from user balances but links them via transaction identifiers. This explicit computational handling distinguishes the system from abstract business concepts and ensures that fee calculation and recording are executed as concrete machine operations over stored data structures.

In an embodiment, the server implements multiple alternative generative AI models and selects among them based on context. The server may maintain different models optimized for different categories, such as industrial design, graphic design, or interior design. The server uses category information derived from the prompt sentence or explicit user selection to route generation requests to a suitable model or model variant. The server may also implement models of different sizes, such as a small, low-latency model for quick previews and a larger, higher-capacity model for final versions. The server dynamically chooses between these based on resource load, desired quality, and response time constraints. This model selection mechanism improves efficiency and overall system performance.

In an embodiment, the server uses specialized loss functions and training regimes to enhance alignment with marketplace needs. For example, the server may incorporate ranking-based loss terms that encourage generation of concepts and designs that receive higher user engagement or purchase rates. The server may augment training data with signals indicating which generated outputs led to successful sales, and may adjust the model accordingly. This feedback loop is implemented as a machine-level training process that updates model parameters to optimize future performance in the specific context of the electronic marketplace, going beyond generic language modeling.

In an embodiment, the server applies custom rules that are not conventional in generic AI pipelines. For example, the server may implement a rule-based constraint module that rejects generated outputs that lack required structural sections or that fail to satisfy design requirements extracted from the prompt sentence, such as the presence of “curved display” and “health tracking sensors” in a smartwatch example. The server may automatically trigger partial regeneration of missing or inconsistent sections using different sampling parameters or execution paths. This non-standard, rule-enforced regeneration approach ensures structural and semantic compliance with marketplace requirements, thus improving consistency and quality.

In an embodiment, the server improves communication load by managing data transfer sizes. The server can compress generation result data and image assets before transmission to terminals and can selectively transmit only necessary fields for each interface screen. For example, the server transmits only title, short description, and thumbnail image for search result listings, and transmits full descriptions and high-resolution images only when a user accesses a detail page. This selective transmission reduces bandwidth consumption and latency and improves user experience.

In an embodiment, the server improves memory usage and processing speed by caching frequently accessed listing information, generation result data, and ownership information. The server may store computed search results or pre-rendered recommendations in a cache memory and reuse them across multiple requests within a time window. The server may also cache model outputs for identical or similar prompt sentences and reuse them when appropriate, further reducing computation demand on the graphics processing unit.

In an embodiment, the server's integrated architecture achieves technical effects that are not realized by mere human-controlled workflows. The server coordinates complex sequences of machine-level operations, including natural language preprocessing, transformer-based generative modeling, structured data construction, database transaction processing, cryptographic transaction signing, distributed ledger synchronization, and optimized search and ranking. Each stage is implemented using specialized data structures, indices, and control flows, resulting in improved processing speed, improved accuracy and consistency of generated and stored data, reduced risk of inconsistent marketplace and ownership states, and lower communication load between the server and terminals. The system thus constitutes an improvement in computer technology, providing a specific, technical implementation of an AI-driven electronic marketplace that achieves enhanced operational characteristics beyond simple automation of human tasks.

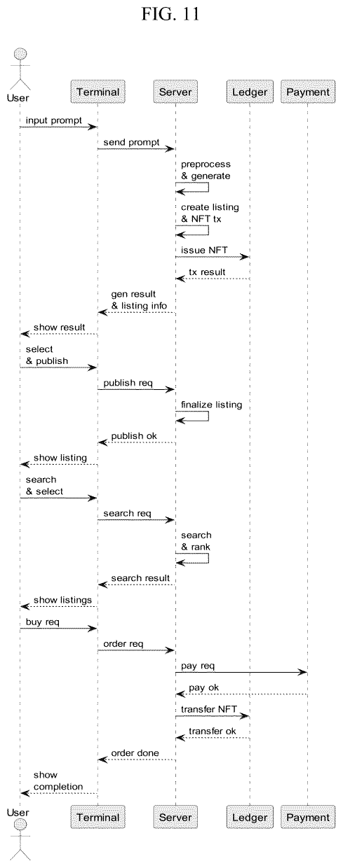

The following describes the processing flow using FIG. 11.

### Step 1:

The user operates the terminal to open a marketplace interface and to input a prompt sentence.

The terminal receives, as input, user keystrokes and pointer operations and converts them into character data representing the prompt sentence and optional parameters such as category and desired number of concepts.

The terminal performs data processing by validating the length of the prompt sentence, checking for forbidden terms, and encoding the character data in a predefined character encoding format.

The terminal outputs a structured request payload including the prompt sentence, user identifier, and auxiliary parameters and transmits this payload to the server via a communication network.

### Step 2:

The server receives the request payload from the terminal.

The server takes, as input, the structured payload including the prompt sentence, user identifier, and auxiliary parameters.

The server performs data parsing operations to convert the payload from a serialized format into internal variables, verifies the authenticity of the user identifier using stored session data, and logs the request metadata.

The server outputs validated generation request data that combines the prompt sentence, user information, and a newly assigned request identifier.

### Step 3:

The server performs natural language preprocessing on the prompt sentence.

The server receives, as input, the text of the prompt sentence and user-related metadata from the generation request data.

The server executes tokenization processing to segment the text into tokens using a vocabulary, applies normalization operations such as lowercasing and removal of extraneous whitespace, and applies length control by truncating or padding the token sequence to a model-defined maximum length.

The server outputs a model-ready token sequence and associated attention masks that are suitable as input to the generative AI model.

### Step 4:

The server executes the generative AI model to generate description data of a concept or design.

The server receives, as input, the token sequence and attention masks produced in Step 3, together with generation parameters such as maximum output length and temperature.

The server performs data computation by applying matrix multiplications, attention calculations, and non-linear activation functions across multiple layers of a transformer-based neural network, iteratively sampling output tokens until a stopping condition is satisfied.

The server outputs a sequence of generated tokens representing text that describes one or more concepts or designs.

### Step 5:

The server decodes the generated tokens and structures the generation result data.

The server receives, as input, the sequence of generated tokens from Step 4.

The server performs decoding operations to map tokens back to characters, detects section markers such as “Title”, “Overview”, and “Features”, and parses the text into a structured object with fields for title, summaries, detailed descriptions, and feature lists.

The server outputs generation result data that includes structured description data of the generated concept or design, associated with the request identifier and user identifier.

### Step 6:

The server generates sales information and listing information for the electronic marketplace.

The server receives, as input, the structured generation result data from Step 5 and marketplace parameters such as a default pricing rule or category selected by the user.

The server performs data transformation by mapping description fields to listing fields, generating attribute information such as category and tags, computing suggested price information using predefined pricing logic, and constructing a normalized sales information record.

The server outputs listing information that encapsulates the sales information, links to the generation result data, and a unique listing identifier, and stores this information in a database.

### Step 7:

The server issues a non-fungible token associated with the listing.

The server receives, as input, the listing information from Step 6, including the listing identifier and content metadata.

The server performs cryptographic data processing by constructing a token metadata object, computing a hash value for integrity verification, serializing an issuance transaction message for a distributed ledger, and signing the message with a private key.

The server outputs a confirmed non-fungible token identifier and a transaction hash after submitting the issuance transaction to the distributed ledger and receiving confirmation, and it records the token identifier and ownership information in association with the listing information.

### Step 8:

The server returns the generation result data and listing registration status to the terminal.

The server receives, as input, the listing identifier, generation result data, and non-fungible token information generated in previous steps.

The server performs data aggregation by combining the description data, sales information, and ownership information into a response structure and serializing it for network transmission.

The server outputs a response message that includes the generated text, structured listing details, and token ownership status and sends this message to the terminal.

### Step 9:

The terminal displays the generated concept or design and listing status to the user.

The terminal receives, as input, the response message from Step 8.

The terminal performs data processing by parsing the response, updating internal state, and generating a user interface using layout algorithms that position titles, descriptions, attributes, and ownership information on the display.

The terminal outputs graphical display data rendered on the screen, allowing the user to visually inspect the generated concept or design and its marketplace registration status.

### Step 10:

The user reviews and optionally refines the generated concept or design.

The user receives, as input, the visual representation of the generated concept or design and associated listing information on the terminal.

The user performs operations such as scrolling, reading, and selecting buttons labeled “Regenerate” or “Refine”, and may modify the original prompt sentence by editing the text input field.

The user outputs a revised prompt sentence and control commands, which the terminal captures and packages into a new or updated generation request payload to be sent to the server.

### Step 11:

The server generates multiple candidate concepts or designs when requested.

The server receives, as input, a prompt sentence and a parameter indicating a requested number of candidates from the terminal.

The server performs repeated generative computations by executing the generative AI model multiple times with varied random seeds or sampling parameters, producing a plurality of token sequences that correspond to different candidate outputs, and then decodes and structures each output into a separate generation result record.

The server outputs a collection of candidate concepts or designs, each with distinct description data, and sends this collection to the terminal for user selection.

### Step 12:

The terminal presents multiple candidate concepts or designs for selection.

The terminal receives, as input, the collection of candidate generation result data from Step 11.

The terminal performs data preparation by organizing candidates into a list or grid, generates distinct display regions for each candidate, and renders thumbnails, titles, and summaries for comparison.

The terminal outputs a selection interface on the display, enabling the user to select one candidate concept or design via input actions such as clicking or tapping.

### Step 13:

The user selects a candidate concept or design for listing.

The user receives, as input, the plurality of candidates displayed on the terminal.

The user performs an explicit selection operation, for example by activating a “Select” control for a preferred candidate and then confirming an action to publish it to the marketplace.

The user outputs selection commands that the terminal converts into a selected candidate identifier and sends to the server as a selection confirmation payload.

### Step 14:

The server finalizes sales information based on the selected candidate.

The server receives, as input, the selected candidate identifier from the terminal and the corresponding candidate generation result data stored in the database.

The server performs data processing by copying and validating the selected candidate's fields, applying any user-specified adjustments to price or attributes, and updating or creating a final sales information record and listing information.

The server outputs updated listing information that reflects the selected candidate and confirms successful registration to the terminal.

### Step 15:

The terminal displays the finalized listing to other users.

The terminal, operated by other users, receives, as input, listing data requested from the server when browsing or searching within the marketplace.

The terminal performs data processing by constructing search result screens or detail pages and by rendering the finalized listing, including title, description, attributes, price, and token ownership status.

The terminal outputs visual listing data that enables other users to understand the offered concept or design and to initiate a potential purchase.

### Step 16:

The server processes search and ranking requests from terminals.

The server receives, as input, search queries or filter conditions from terminals, which may contain keywords derived from prompt sentences or user-entered criteria.

The server performs data computation by querying indexed listing fields and transaction history, computing relevance scores based on keyword matches, vector similarity, and engagement metrics, and sorting results by combined ranking scores.

The server outputs an ordered list of listing information records that match the search request and transmits this list to the requesting terminal.

### Step 17:

The user initiates a purchase request for a listed concept or design.

The user receives, as input, listing information and token ownership status displayed on the terminal.

The user performs operations such as clicking a “Buy now” control, confirming purchase conditions, and providing necessary payment-related inputs.

The user outputs purchase commands and associated data, which the terminal encapsulates as a purchase request payload containing a listing identifier and buyer information and sends to the server.

### Step 18:

The server coordinates payment processing and fee calculation.

The server receives, as input, the purchase request payload including the listing identifier and buyer information.

The server performs data operations by retrieving the relevant listing and seller information, computing the total price and applicable service fee using arithmetic operations, and constructing a payment initiation message for an external payment processing apparatus.

The server outputs a payment session identifier and a pending order record, and forwards the payment initiation message to the payment processing apparatus.

### Step 19:

The server finalizes the purchase and executes ownership transfer on the distributed ledger.

The server receives, as input, a payment confirmation notification from the payment processing apparatus and the existing ownership information of the non-fungible token linked to the listing.

The server performs data computation by updating the order record to a completed state, recording the calculated fee as revenue information, constructing and signing an ownership transfer transaction for the non-fungible token, and submitting the transaction to the distributed ledger network.

The server outputs updated ownership information and transaction history entries once the ledger confirms the ownership transfer, and stores these updates in the database.

### Step 20:

The terminal of the buyer displays completion and access information.

The terminal of the buyer receives, as input, a completion response from the server that includes updated ownership information, download links, and transaction identifiers.

The terminal performs data processing by parsing the response, updating local state regarding owned content, and constructing a completion screen displaying messages such as purchase confirmation and availability of the concept or design for download or further use.

The terminal outputs visual confirmation and control elements that allow the user to access the acquired concept or design and to verify token-based ownership information.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional systems that utilize generative AI models to create concepts or designs from user-provided prompt sentences generally treat the generative AI model as a standalone content generator. Such systems typically return generated text or media to the originating user without providing integrated mechanisms for secure ownership registration, controlled distribution, or transaction management. As a result, several technical problems arise in the context of computer-implemented content generation and distribution platforms. First, conventional architectures do not tightly couple prompt handling, model invocation, and token-based ownership registration within a single coordinated processing pipeline on a server. Prompt sentences are often passed directly to a generative AI model without standardized pre-processing, authentication verification, or content review. This leads to inconsistent input quality, non-deterministic model behavior, and difficulty in enforcing platform-wide policies at the server level. It also complicates server-side optimization and monitoring because prompt processing and model invocation are scattered or handled in an ad hoc manner.

Second, existing platforms lack a unified server-side representation of generated digital content that links the content data, user identification data, and ownership metadata in a machine-manageable structure. Generated content is frequently stored as unstructured blobs or isolated files. Such storage approaches hinder efficient indexing, retrieval, access control, and subsequent association with non-fungible tokens on a distributed ledger system. As a consequence, the server cannot reliably perform automated publication control, transfer of ownership, or auditing of transactions based on a coherent internal content model.

Third, many systems that integrate non-fungible tokens and digital content perform blockchain operations and marketplace operations in loosely connected subsystems. In such configurations, token minting, ownership registration, listing, and transaction execution are decoupled, resulting in race conditions, inconsistent state between the on-chain ownership records and the off-chain content database, and increased latency. The server is not architected to atomically or deterministically coordinate the distributed ledger operations with internal database updates, which degrades reliability of transaction processing and makes it difficult to maintain accurate transaction history and fee accounting. Fourth, conventional electronic marketplaces for digital assets do not provide a server-centric mechanism that continuously manages, for each generated asset, the complete lifecycle from prompt reception, AI-based generation, ownership tokenization, listing, purchase processing, and fee management. Parameters such as price information, transaction conditions, and publication states are often managed in disparate modules or manual workflows. This fragmentation increases the complexity of the software stack, introduces inconsistencies in user-visible state, and prevents the server from efficiently enforcing policy-based changes or optimizing data structures for low-latency access and high-throughput transaction processing. Accordingly, there is a need for an improved computer-implemented system in which a server, through a processor executing specialized instructions, performs an integrated sequence of operations: securely receiving and analyzing prompt sentences; invoking a generative AI model using normalized generation input data; storing generated digital content as structured information distribution platform content data; generating and associating non-fungible tokens on a distributed ledger system to register ownership information; managing publication, sale, and purchase workflows; and recording transaction history and fee information as revenue information. By reorganizing these operations into a cohesive, server-controlled pipeline, the invention aims to improve the technical functioning of the underlying computer platform, including consistency of state across subsystems, efficiency of content and transaction management, and reliability of ownership and revenue tracking.

The specific processing by the specific processing unit 290 of the data processing device 12 in Application Example 1 is realized by the following means.

The present invention provides a server comprising a processor configured to receive, via a communication network, a prompt sentence and user information that are input by a user through a terminal; perform authentication processing and content review processing on the received prompt sentence and the user information to generate generation input data; input the generation input data into a generative AI model and cause the generative AI model to generate digital content including a concept or a design based on the prompt sentence; normalize the digital content output from the generative AI model into a predetermined internal format and store the digital content as information distribution platform content data by assigning an identifier, user identification information, and attribute information to the digital content; generate, on a distributed ledger system, a non-fungible token corresponding to the information distribution platform content data and register ownership information by associating the non-fungible token with the information distribution platform content data; publish the information distribution platform content data, for which the ownership information is registered, as a saleable asset in an electronic marketplace and, in response to a viewing request, distribute information related to the saleable asset to another terminal; accept, in the electronic marketplace, a purchase request for the saleable asset, execute settlement processing and rights transfer processing of the non-fungible token, and generate transaction data; and record transaction history information and fee information based on the transaction data and manage the fee information as revenue information. This enables the server to implement an integrated, computer-implemented pipeline that consistently links prompt processing, AI-based content generation, structured content storage, distributed ledger ownership registration, marketplace publication, and transaction accounting, thereby improving the technical performance, reliability, and state consistency of the underlying content generation and distribution platform.

The term “processor” refers to one or more hardware data processing units, such as a central processing unit, a graphics processing unit, or another integrated circuit, configured to execute instructions and perform arithmetic, logical, and control operations.

The term “communication network” refers to any wired or wireless data communication infrastructure, including local area networks, wide area networks, or public networks, that enables digital data to be transmitted between the server and one or more terminals.

The term “terminal” refers to any user-operated electronic apparatus, such as a mobile device, a head-mounted display, or a general-purpose computing device, that provides an interface for inputting data to and receiving data from the server via the communication network.

The term “user” refers to any human operator or entity that interacts with the system through a terminal to input data, view data, or initiate transactions.

The term “prompt sentence” refers to a sequence of characters representing a natural language instruction, query, or description, which is input by the user and used as a primary control input to a generative AI model.

The term “user information” refers to data associated with a user, including at least one of identification data, authentication data, profile data, or account configuration data, which is used by the server to control access and personalize processing.

The term “authentication processing” refers to server-side operations that verify the validity of user information or credentials, such as passwords, tokens, or cryptographic signatures, in order to determine whether access to system functions should be granted.

The term “content review processing” refers to analysis performed by the server on the prompt sentence or digital content to determine compliance with predetermined policies, such as safety guidelines, legal restrictions, or quality thresholds.

The term “generation input data” refers to structured data derived from the prompt sentence and optionally from user information or control parameters, which is formatted for input into the generative AI model to control the generation of digital content.

The term “generative AI model” refers to a machine-learned computational model, such as a neural network, which is configured to generate new data, including text, images, or structured representations, in response to input data such as a prompt sentence.

The term “digital content” refers to electronically represented information generated by the generative AI model, including at least one of text, structured descriptions, designs, layouts, or other machine-readable representations of concepts or designs.

The term “concept” refers to an abstract or high-level description of an idea, structure, or functionality, represented in digital form, which is generated or manipulated by the system.

The term “design” refers to a digital specification or arrangement of elements, such as components, shapes, or functional modules, which describes the structure, appearance, or behavior of a product, environment, or system.

The term “predetermined internal format” refers to a data schema or representation defined in advance by the system, which specifies fields, data types, and relationships used to store digital content in a consistent machine-readable structure.

The term “information distribution platform content data” refers to a data object stored in the system that represents digital content along with associated metadata, structured according to the predetermined internal format for use in an information distribution platform.

The term “identifier” refers to a unique data value, such as a numeric or alphanumeric code, that is assigned by the system to distinguish a particular content item or token from other items within the system.

The term “user identification information” refers to data used by the system to associate a digital content item with a specific user, such as a user ID, account ID, or cryptographic address.

The term “attribute information” refers to metadata associated with digital content, including at least one of category, tags, creation time, status, price, or other descriptive properties managed by the server.

The term “distributed ledger system” refers to a networked data storage system, such as a blockchain network, in which records are maintained in a distributed manner across multiple nodes and updated through a consensus process.

The term “non-fungible token” refers to a unique digital token recorded on a distributed ledger system that represents ownership or rights associated with a specific digital content item and is distinguishable from other tokens.

The term “ownership information” refers to data indicating a right of possession or control over a digital content item or a corresponding non-fungible token, including at least an owner identifier or address.

The term “electronic marketplace” refers to a computer-implemented environment operated by the server that presents digital content items as assets, enables users to list, browse, purchase, or sell such assets, and manages related transaction data.

The term “saleable asset” refers to an item of information distribution platform content data that has been designated by the server as available for purchase or transfer within the electronic marketplace.

The term “viewing request” refers to a message transmitted from a terminal to the server that requests retrieval and presentation of information related to one or more saleable assets.

The term “purchase request” refers to a message transmitted from a terminal to the server that indicates a user's intent to acquire a saleable asset under specified conditions.

The term “settlement processing” refers to server-controlled operations that execute payment-related actions for a purchase transaction, including debiting a buyer, crediting a seller, or communicating with an external payment service.

The term “rights transfer processing” refers to operations performed by the server and the distributed ledger system to change ownership information of a non-fungible token from a seller to a buyer.

The term “transaction data” refers to structured data representing a completed or attempted transaction, including at least one of identifiers of parties, identifiers of assets, price, timestamps, and result status.

The term “transaction history information” refers to data derived from one or more instances of transaction data, stored in association with content items or users, and used to record a chronological history of transactions.

The term “fee information” refers to data representing charges, commissions, or other fees calculated by the server in association with one or more transactions.

The term “revenue information” refers to data managed by the server that aggregates or organizes fee information and related monetary values to represent income of the platform or service operator.

The term “natural language processing technique” refers to a computational procedure that analyzes or transforms human language text, including operations such as tokenization, parsing, classification, or semantic analysis, executed by the processor.

The term “control parameters” refers to values supplied to the generative AI model that affect its operation, such as temperature, maximum output length, style indicators, or other model configuration variables.

The term “classification information” refers to category or label data derived from the prompt sentence or other inputs, which is used to influence or organize the generation, storage, or presentation of digital content.

The term “additional instruction information” refers to supplementary directives or constraints, distinct from the main prompt sentence, which are supplied to the generative AI model to guide the generation of digital content.

The term “price information” refers to data specifying a monetary or token amount or pricing rule associated with a saleable asset in the electronic marketplace.

The term “transaction condition information” refers to data specifying conditions under which a saleable asset may be purchased or transferred, including payment methods, time limits, or access restrictions.

The term “publication state information” refers to data that indicates whether and how a saleable asset is exposed within the electronic marketplace, such as public, private, or limited-access visibility states.

The term “publication range” refers to the scope of users or contexts in which information distribution platform content data is made visible or accessible within the electronic marketplace.

The term “sale state” refers to a status value indicating whether a content item is currently available for sale, reserved, sold, or otherwise not actively tradable in the electronic marketplace.

In one embodiment, a server, one or more terminals, and a communication network cooperate to implement a system for generating, registering, and trading digital content derived from a user-provided prompt sentence using a generative AI model. The server comprises at least one processor, a main memory, a non-volatile storage device, a network interface, and optionally an interface to a distributed ledger system. The terminal comprises at least one processor, a memory, an input device, a display device, and a communication module.

The server executes server-side application software implemented, for example, as a web application framework or an application program running on a general-purpose operating system. The server uses a database management system to store structured data, and uses a storage service to store large content data. The server further uses an AI execution environment including a generative AI model implemented as a neural network, and uses a distributed ledger client library to communicate with a distributed ledger system. The server structures internal data into specific data objects, such as prompt objects, generation input data objects, digital content objects, and transaction objects, each having predetermined fields.

The terminal executes client-side application software, for example a mobile application or a browser-based application, that provides a graphical user interface. The terminal provides input components for entering a prompt sentence, buttons for sending the prompt sentence to the server, and display components for showing generated digital content and marketplace information. The terminal uses a transport protocol such as HTTPS to send and receive structured messages, for example encoded in JSON, to and from the server.

The user operates the terminal to input a prompt sentence. The user may enter a prompt sentence directly through a text input field, may select a previously stored prompt sentence from a history list, or may modify an existing prompt sentence. Example prompt sentences include:

“Design a futuristic cityscape with floating parks and autonomous transit systems.”

“Design a modular smart home interior optimized for remote work and energy efficiency.”

“Generate a blueprint for an eco-friendly urban park that integrates water recycling and solar lighting.”

“Create a conceptual design for a wearable health-monitoring device that can pair with smart glasses.”

“Propose a futuristic public transportation hub that connects autonomous buses, drones, and high-speed rails.”

The terminal transmits the prompt sentence, together with user identification information and optional control parameters, to the server. The server receives the prompt sentence and the associated user information via the communication network. The server stores the received prompt sentence in a prompt object having at least fields such as prompt id, user_id, prompt_text, timestamp, and policy_status.

The server performs authentication processing by accessing user records in the database and verifying tokens or credentials included in the user information. The server performs content review processing by applying a natural language processing module to the prompt sentence.

The server, for example, tokenizes the prompt sentence, encodes the tokens into vector representations, and passes the vector sequence through a text classification model that has been trained to detect disallowed content categories. The server assigns a policy_status field indicating whether the prompt sentence is acceptable or rejected. If the policy_status indicates rejection, the server generates a rejection response, and the terminal displays a notification to the user.

If the prompt sentence is accepted, the server generates generation input data. The server normalizes the prompt sentence by applying operations such as Unicode normalization, whitespace normalization, and language detection. The server may generate additional control parameters based on the content of the prompt sentence, such as a content category, an expected output length, or style hints. The server may generate classification information indicating, for example, that a given prompt sentence pertains to “urban design,” “product design,” or “wearable device design.” The server may generate additional instruction information that constrains the generative AI model, such as instruction to produce structured sections “Title,” “Summary,” and “Details.”

The server constructs a generation input data object having fields such as input id, prompt_text, control_parameters, classification_information, and additional_instruction_information. By storing this information in a unified structure, the server enables later auditability and repeatability of the generative process. The server transfers the fields of the generation input data object to the generative AI model.

The server hosts or accesses the generative AI model on a computation platform configured for accelerated linear algebra operations. The generative AI model comprises a deep neural network, for example a transformer-type sequence model. The generative AI model includes an input embedding layer, a positional encoding mechanism, a plurality of attention layers, a plurality of feedforward layers, and an output layer that maps internal representations to token probabilities. The generative AI model has been trained in advance using a large corpus of training data. The server uses a training procedure comprising at least the following elements: a loss function such as cross-entropy, an optimization algorithm such as stochastic gradient descent with adaptive moment estimation, mini-batch training, and gradient-based weight updates. The server may use data augmentation techniques such as random masking or shuffling during training to improve robustness.

The server, during inference, converts the prompt sentence text into a sequence of tokens, converts the tokens to embedding vectors, and processes the embedding sequence through the multiple layers of the generative AI model. The generative AI model computes attention scores between tokens, applies matrix multiplications and non-linear activation functions, and generates a sequence of output tokens representing the digital content. The server controls sampling parameters such as temperature or top-k probability thresholds so that the generated content satisfies desired diversity and determinism properties. By using this specific model architecture and parameter control, the server enables higher-quality and more consistent output than manual human drafting or simple rule-based generation.

The server receives the output tokens from the generative AI model and reconstructs the generated digital content as a text sequence or structured representation. The server may impose structural constraints by inserting explicit section delimiters, forcing the model to produce “Title:”, “Summary:”, and “Details:” fields. The server parses the generated digital content based on these delimiters and constructs a digital content object having predetermined fields, such as content_id, user_id, title, summary, body, tags, category, quality_score, and creation_time.

The server assigns a unique identifier to the digital content object using an internal identifier generator. The server associates user identification information with the digital content object to link ownership at the platform level. The server calculates attribute information such as estimated reading time, keyword list, and semantic similarity to existing content by applying vector embedding techniques and similarity metrics. By generating and storing these attribute fields, the server improves indexing and retrieval performance in the electronic marketplace.

The server stores the digital content object in a database table configured for the information distribution platform. The server stores large text bodies in a storage service and references them via content_url fields in the digital content object. The server uses indexing strategies such as B-tree indices on content_id and user_id fields, and full-text search indices on title and tags fields. These data structures enable high-speed queries on content data and reduce database load, improving responsiveness of the marketplace operations.

The server generates a non-fungible token by interacting with a distributed ledger system. The server constructs metadata describing the digital content, including at least the title, a description, a content_url, and a hash of the content data for integrity verification. The server computes the hash using a cryptographic hash function, such as a hash function from a secure hash family, to ensure that any modification of the digital content can be detected. The server encodes the metadata according to the token metadata standard used by the distributed ledger system. The server creates a transaction to invoke a function of a token smart contract deployed on the distributed ledger system. The server specifies the destination address, which corresponds to a wallet managed by or associated with the user, and specifies the metadata URI.

The terminal may present a wallet interface, and the user may confirm or deny the token creation transaction. The terminal may use a secure enclave or a secure element to store private keys. The terminal signs the transaction and transmits it to the distributed ledger system. The distributed ledger system validates the transaction and records it in a distributed ledger. The server monitors the distributed ledger for confirmation of the transaction. When the transaction is confirmed, the server retrieves the token identifier and records it in the digital content object as nft_token_id, nft_contract_address, and chain_identifier.

The server thereby registers ownership information that links the digital content stored off-chain with the non-fungible token stored on-chain. The server ensures that the mapping from content_id to nft_token_id is stored in a consistent manner, enabling the server to detect and reconcile any discrepancies between platform-level ownership and ledger-level ownership. This integrated data structure, combining off-chain structured content data and on-chain ownership data, improves the precision and reliability of ownership tracking, reduces errors due to inconsistent records, and enables automatic verification of ownership state.

The server presents the digital content as a saleable asset in an electronic marketplace. The terminal displays a list of saleable assets with associated metadata fields. The user may adjust price information, transaction condition information, and publication state information using controls on the terminal. The server records these values in marketplace-specific data structures, such as listing objects including fields listing_id, content_id, seller_user_id, price_value, currency_type, sale_state, publication_state, and validity_period.

The server maintains a state machine for each listing, so that transitions between states, such as draft, listed, reserved, sold, or canceled, follow well-defined rules, and so that on-chain and off-chain data remain synchronized. The server updates the sale state and publication range based on the user's input and system rules. The terminal reflects these changes in real-time, so that users see up-to-date availability and pricing information. By maintaining explicit listing objects and state machines, the server reduces the risk of race conditions where multiple users attempt to purchase the same asset simultaneously.

The server handles purchase requests for saleable assets. The terminal sends a purchase request including identifiers and payment information. The server verifies that the asset is still in a saleable state, and then performs settlement processing. The server may integrate with an external payment system for currency-based payments, or may invoke a smart contract function for ledger-based payments. The server executes algorithmic checks, such as verifying sufficient balance and anti-duplication transaction identifiers, before recording the transaction.

The server constructs transaction data objects including fields such as transaction_id, buyer_user_id, seller_user_id, content_id, nft_token_id, price value, currency type, timestamp, payment_status, and ledger_transaction_hash. The server updates ownership information by changing the user_id associated with the digital content object and by monitoring the ledger for completion of the token transfer. The server records transaction history information by appending transaction data to a transaction history table linked to the content and user records. The server calculates fee information using predetermined algorithms, such as a percentage of the price_value, and records fee amounts in a revenue information structure.

The server thereby provides a technically improved transaction processing pipeline compared to conventional systems. The server uses specific data structures, such as generation input data objects, digital content objects, listing objects, and transaction objects, and specifically coordinates them with non-fungible token operations. This design improves data consistency, reduces redundant write operations, and allows optimized database indexing strategies. As a result, transaction throughput increases, response latency decreases, and risk of inconsistent ownership state is reduced.

The server improves computer technology in several ways. The server reduces duplicate computations by caching vector representations of prompt sentences and using them for both content generation and policy checking, thus reducing overall processing time and resource usage. The server reduces communication load by aggregating metadata fields and compressing data when transmitting content previews to terminals, thereby minimizing bandwidth usage while maintaining sufficient information for user decisions. The server improves accuracy of policy enforcement by using internal classification models that operate on high-dimensional embeddings rather than simple keyword matching, which reduces false positives and false negatives in content filtering.

The server employs a non-conventional integration of modules. Unlike simple automation of human actions, the server employs a specific generative AI model architecture with structured control parameters, a unified internal content representation, and a stateful linkage to a distributed ledger system. The server uses predetermined, non-intuitive data flows: for example, the server generates additional instruction information to guide the generative AI model to produce machine-parseable sections, and the server uses content hashes stored in token metadata fields to verify integrity during later marketplace operations. These features enable repeatable, verifiable, and automatically analyzable content generation and trading processes that a human operator cannot perform manually at comparable speed or scale. The server may support multiple embodiments and variations. The server may use different neural network architectures, such as encoder-decoder models, convolutional sequence models, or recurrent neural networks, provided that the models accept generation input data and output digital content. The server may use different distributed ledger systems, provided that non-fungible tokens can be issued and transferred. The server may store content either entirely on-chain for small content or off-chain for large content. The server may use different algorithms for calculating quality scores, such as using machine-learned regression models or rule-based scoring, and may use different indexing and caching strategies to further optimize performance.

The terminal may be embodied as a handheld device, a head-mounted display, or a general-purpose computing device. The terminal may be configured to provide augmented reality or virtual reality views of generated designs, by rendering digital content in a three-dimensional environment. The user may interact with such designs by gestures or voice commands sent from the terminal to the server. The server may then update associated metadata and generate new content variants in response to such interactions. In such embodiments, the system controls not only the storage and trading of digital content but also the presentation and interaction of designs in real environments, thereby further illustrating technical use beyond abstract data manipulation.

In summary, the server, the terminal, and the user cooperate so that the system provides an integrated, technically specific mechanism for receiving and processing a prompt sentence, generating digital content using a generative AI model, registering ownership using a non-fungible token on a distributed ledger system, and managing marketplace operations with structured data objects and defined state transitions. This configuration yields concrete technical effects in the operation of computer hardware and networks, such as improved processing efficiency, enhanced data consistency, and reduced communication load, and thus provides more than a mere automation of human mental activities.

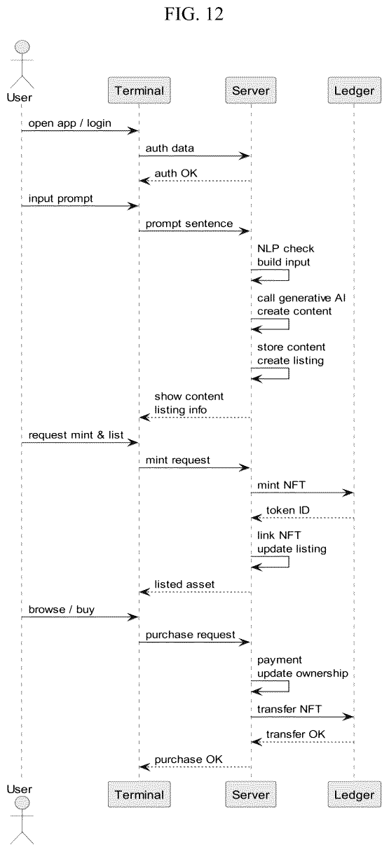

The following describes the processing flow using FIG. 12.

### Step 1:

The user operates the terminal to launch a marketplace application and to authenticate.

The terminal displays a login screen and receives input such as a user identifier and a credential.

The terminal sends the user identifier and the credential to the server as a login request.

The server receives the login request as input and compares the credential with authentication data stored in a user table of a database.

The server, based on a matching operation between the received credential and the stored authentication data, outputs an authentication result and, when successful, generates an authentication token.

The server sends the authentication token to the terminal, and the terminal stores the authentication token in a secure storage area for later use.

### Step 2:

The user operates the terminal to open a prompt input screen and to enter a prompt sentence.

The terminal receives the prompt sentence as input through a text field, and the terminal optionally receives a category selection and generation options.

The terminal performs local validation by checking that the prompt sentence is not empty and that the length does not exceed a predefined limit.

The terminal outputs a message object including the prompt sentence, the category, the generation options, and the authentication token.

### Step 3:

The terminal sends the message object to the server using a secure communication protocol.

The server receives the message object as input and extracts the authentication token, the prompt sentence, and the category.

The server verifies the authentication token by decoding it and checking signature and expiration fields.

The server outputs a verified-user context and a normalized prompt representation.

### Step 4:

The server performs content review processing on the prompt sentence.

The server uses a natural language processing module to tokenize the prompt sentence, convert tokens into embeddings, and input the embeddings into a classification model.

The server receives classification scores as output and compares the scores with threshold values to detect prohibited categories.

The server outputs a policy_status value indicating whether the prompt sentence is allowed or rejected.

The server, when the policy_status indicates rejection, generates an error response and sends the error response to the terminal.

The terminal receives the error response as input and displays a notification to the user indicating that the prompt sentence must be modified.

### Step 5:

The server, when the policy_status indicates that the prompt sentence is allowed, generates generation input data.

The server receives as input the normalized prompt representation, the category, and the verified-user context.

The server performs data processing operations, including removing redundant whitespace, performing language detection, and generating control parameters such as maximum output length and style indicators.

The server outputs a generation input data structure that includes fields for the prompt sentence, control parameters, classification information, and additional instruction information.

### Step 6:

The server invokes the generative AI model using the generation input data as input.

The server converts the prompt sentence into a sequence of tokens using a tokenizer, converts the tokens into embedding vectors, and supplies the vectors and control parameters to the generative AI model.

The generative AI model, implemented as a multi-layer neural network, performs matrix multiplications, attention operations, and non-linear activations to compute probabilities for output tokens.

The server receives sequences of probability distributions from the generative AI model and performs sampling according to parameters such as temperature and top-k thresholds.

The server outputs a sequence of output tokens that represent the generated digital content.

Step 7: The server reconstructs the digital content from the output tokens.

The server receives the token sequence as input and converts each token to a text fragment by referring to a vocabulary mapping.

The server concatenates the text fragments, detects section boundaries such as “Title:”, “Summary:”, and “Details:”, and parses the text into structured fields.

The server outputs a digital content object that includes at least a title field, a summary field, a body field, and associated tags.

### Step 8:

The server assigns identifiers and metadata to the digital content object.

The server receives the digital content object and the verified-user context as input.

The server generates a unique content identifier, records a timestamp, and associates the user identifier of the authenticated user with the content identifier.

The server computes attribute information such as a list of keywords and a quality score by applying vector embedding techniques and counting structural features of the content.

The server outputs an enriched digital content object with added identifier, user identification information, and attribute information.

### Step 9:

The server stores the enriched digital content object in an information distribution platform.

The server receives the enriched digital content object as input and writes formatted records to one or more database tables.

The server stores long text data in a storage service and writes only a reference URL into the content record.

The server creates database indices on fields such as content identifier, user identifier, and category to accelerate future queries.

The server outputs a stored content record and returns a confirmation message including the content identifier to the terminal.

The terminal receives the confirmation message as input and updates the user interface to display a preview of the generated digital content.

### Step 10:

The user reviews the generated digital content on the terminal.

The terminal displays the title, summary, and body fields, and the user scrolls and reads them. The user edits parts of the content, such as changing the title or adjusting some paragraphs.

The terminal captures the edited content fields as input and computes a difference between original content and edited content.

The terminal outputs an update request that includes the content identifier and the edited fields.

### Step 11:

The terminal sends the update request to the server.

The server receives the update request as input and verifies that the user is the owner of the content by comparing user identifiers.

The server replaces stored fields with the edited fields and updates the modification timestamp and a version number.

The server outputs an updated content record and sends a success response to the terminal.

The terminal receives the success response and displays that the content is now ready for tokenization or publication.

### Step 12:

The user initiates tokenization and listing from the terminal.

The terminal presents controls such as “Create Token” and “List for Sale” and receives a user selection as input.

The user selects a price, a currency type, and a publication state.

The terminal forms a listing request including the content identifier, listing parameters, and an instruction to mint a non-fungible token, and outputs the listing request.

### Step 13:

The terminal sends the listing request to the server.

The server receives the listing request as input and verifies that the content identifier is valid and that the current user is the owner.

The server creates a listing object that includes the content identifier, the owner user identifier, the price, the currency, the sale state, and the publication state.

The server stores the listing object in a marketplace table and outputs a listing identifier associated with the content.

### Step 14:

The server prepares non-fungible token metadata for the content.

The server receives as input the content record and the listing object.

The server computes a hash of the content body to ensure integrity, constructs a metadata document including a title, description, and content URL, and encodes the document according to a token metadata format.

The server outputs a token metadata URI and a token creation request.

### Step 15:

The terminal or the server interacts with a distributed ledger system to mint the non-fungible token.

The server sends the token creation request to a ledger client and specifies a destination address corresponding to the user's wallet.

The terminal, when necessary, receives a signing request as input and prompts the user to authorize the transaction.

The terminal signs the transaction with a private key stored in a secure storage element and outputs a signed transaction.

The distributed ledger system processes the signed transaction and outputs a transaction receipt containing a token identifier.

The server receives the token identifier and associates it with the content identifier and listing identifier.

Step 16: The server updates ownership information and marketplace state.

The server receives the token identifier and the transaction receipt as input.

The server writes the token identifier, contract address, and chain identifier into fields of the content record and marks the content as tokenized.

The server updates the listing object to reflect a sale state of “available” and a publication state of “public” when indicated by the user.

The server outputs updated content records and listing records and makes them accessible to queries from other terminals.

Step 17: Another user browses the electronic marketplace through a terminal.

The terminal sends a listing query to the server as input, specifying filters such as category or price range.

The server executes database queries using indices on category, price, and sale state to retrieve matching listing records efficiently.

The server outputs a list of saleable assets including content identifiers, titles, prices, thumbnails, and brief summaries.

The terminal receives the list and displays a gallery of items to the user.

Step 18: The other user selects a saleable asset and views detailed information.

The terminal sends a detail request including the selected content identifier as input.

The server retrieves the corresponding content record, listing record, and token information and outputs full details including title, summary, body, owner information, price, and transaction history.

The terminal receives the detailed information and displays it on a detail screen for the user.

Step 19: The other user initiates a purchase for the selected saleable asset.

The terminal receives a purchase command as input and prompts the user to confirm payment details.

The terminal forms a purchase request that includes the content identifier, the listing identifier, a payment method, and buyer user information, and outputs the purchase request.

### Step 20:

The terminal sends the purchase request to the server.

The server receives the purchase request as input and verifies that the listing is still in a saleable state and that the buyer is not the current owner.

The server computes a total payment amount, including any fees, and initiates settlement processing with a payment service or a ledger-based payment mechanism.

The server receives a payment confirmation or failure code as output and, when successful, updates the purchase request status to approved.

### Step 21:

The server performs rights transfer processing for the non-fungible token.

The server constructs a transfer transaction call that specifies the token identifier, the current owner address, and the buyer address.

The terminal associated with the seller or buyer may receive a signing request as input when manual signing is required.

The terminal signs the transfer transaction and outputs a signed transfer message.

The distributed ledger system processes the transfer message and outputs a transaction receipt that indicates successful transfer of token ownership.

The server receives the transaction receipt and updates the content record and listing record to reflect the new owner and a sale state of “sold.”

### Step 22:

The server records transaction data and fee information.

The server receives the payment confirmation and the token transfer receipt as input.

The server constructs a transaction object that combines identifiers for the buyer, the seller, the content, the token, the price, the payment method, and timestamps.

The server calculates a platform fee based on a predetermined rate and stores fee information in association with the transaction object.

The server outputs updated user balance information, transaction history entries, and fee records and stores them in corresponding tables.

The terminal of the buyer receives a purchase success message and displays that the asset has been added to the buyer's owned assets list.

The terminal of the seller receives a notification showing that the asset has been sold and that revenue has been recorded.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented marketplaces for digital content suffer from several technical limitations when handling ideas and designs generated by generative artificial intelligence models. Typical systems treat such content as ordinary files stored in a generic repository and rely on simple database records and ad-hoc business logic to manage ownership, search, and transactions. As a result, the systems exhibit technical inefficiencies and weaknesses in at least the following aspects.

First, existing systems generally do not integrate prompt-level control and history-based feedback into the generation pipeline of the generative artificial intelligence model. Prompt sentences and generated outputs are often discarded or stored in an unstructured way, without being exploited as structured history information for dynamically adjusting input parameters or auxiliary prompts. This leads to sub-optimal use of computing resources, because the same or similar prompts may be processed repeatedly without adaptive tuning, and the quality, consistency, and diversity of generated concept or design information are not systematically improved over time.
Second, conventional marketplace back-ends typically treat the digital content as generic records in an application database, without tightly coupling non-fungible token information and rights states into a unified data model and transaction flow. In such systems, cryptographic identifiers or distributed ledger entries, if present at all, are handled as loosely associated metadata. This fragmented handling complicates management of ownership and license states across storage layers, causes inconsistencies between application-level records and ledger-level records, and increases processing overhead for synchronizing states during listing, purchase, and transfer operations.
Third, traditional electronic marketplace servers generally employ basic search and ranking mechanisms that are unaware of the detailed transaction history and mutual evaluation data of users. Reliability indicators may be stored but are not deeply integrated into search result ordering or visibility control at the system level. Consequently, the server cannot technically optimize the data retrieval and ranking pipeline based on user reliability or tokenized ownership status, leading to inefficient presentation of results, unnecessary network traffic, and reduced trust in the platform.
Fourth, while some systems attempt to detect fraudulent behavior by simple rule-based checks, they do not systematically generate feature quantities from granular transaction fee information and evaluation information, nor do they integrate statistical analysis or machine learning processing into the core transaction processing pipeline. As a result, the server performs fraud detection as an afterthought, often in offline batch processes, which leads to delayed response to anomalous activities and requires additional computation and storage overhead, degrading overall system performance and reliability.
In view of the above, there is a need for an improved computer-implemented technique in which a server centrally manages prompt sentences, generative artificial intelligence model interactions, electronic marketplace data, non-fungible token information, user evaluation information, and fraud detection information in an integrated architecture. It is desirable to provide a server-side mechanism that (i) structurally records prompt sentences and generated outputs as history information and uses that information to technically improve the behavior of the generative artificial intelligence model, (ii) cryptographically binds transaction target information to unique non-fungible token identifiers stored in a ledger, (iii) dynamically controls search and display based on user reliability, and (iv) performs fraud detection using statistical or machine learning processing, thereby enhancing the technical performance, robustness, and transparency of the electronic marketplace system as a whole.

The specific processing by the specific processing unit 290 of the data processing device 12 in Example 2 is realized by the following means.

The present invention provides a server comprising a processor and a storage device, the processor being configured to receive, via a communication interface, a prompt sentence and user identification information from a terminal, to analyze the prompt sentence by using a natural language processing function to generate input data for a generative artificial intelligence model, to supply the input data to the generative artificial intelligence model so as to cause the generative artificial intelligence model to generate concept information or design information, to convert output of the generative artificial intelligence model into storage-ready data and store the storage-ready data together with associated identification information in an electronic marketplace database as transaction target information, to generate for each item of the transaction target information a unique identifier by using a cryptographic method and to record a correspondence between the unique identifier and the transaction target information in a ledger as non-fungible token information, to record the prompt sentence and the concept information or the design information as history information and generate, from the history information, an input parameter or prompt assistance information for the generative artificial intelligence model, to receive evaluation information and transaction fee information and generate a feature quantity for fraudulent transaction detection, and to control search results, display order, and transaction restriction processing in the electronic marketplace based on reliability information for each user and on a determination result obtained by statistical analysis processing or machine learning processing of the feature quantity. This enables an integrated computer-implemented architecture in which the server technically optimizes generative artificial intelligence model behavior using structured history information, cryptographically binds transaction target information to non-fungible token identifiers in a ledger, dynamically adjusts marketplace retrieval and ranking based on user reliability, and performs real-time or near real-time fraud detection using statistical or machine learning techniques, thereby improving processing efficiency, state consistency, security, and transparency of the electronic marketplace system.

The term “processor” refers to one or more hardware processing units or processing circuits, such as a central processing unit, a graphics processing unit, a digital signal processor, or any combination thereof, configured to execute instructions to perform the functions described herein.

The term “terminal” refers to an information processing apparatus operated by a user, such as a personal computer, a mobile communication device, a tablet device, or any other computing device capable of communicating with the server via a communication network.
The term “prompt sentence” refers to a natural language text string or equivalent input expression provided by a user through the terminal, which specifies requirements, constraints, or intentions to be supplied as input to a generative artificial intelligence model.
The term “generative artificial intelligence model” refers to a trained computational model, such as a neural network model, that receives input data including a prompt sentence and automatically generates output data representing concept information, design information, or other synthesized content.
The term “natural language processing function” refers to computer-implemented processing that analyzes a prompt sentence or other text data, including at least one of tokenization, syntactic analysis, semantic analysis, or feature extraction, in order to generate input data suitable for a generative artificial intelligence model.
The term “concept information” refers to abstract content generated by the generative artificial intelligence model, including at least one of textual descriptions, structural representations, or high-level specifications of ideas, which can be treated as transaction target information in an electronic marketplace.
The term “design information” refers to concrete content generated by the generative artificial intelligence model, including at least one of images, diagrams, layouts, or formatted text, which represents a design or creative work that can be treated as transaction target information in an electronic marketplace.
The term “storage device” refers to any non-transitory computer-readable medium or storage apparatus, including volatile memory, non-volatile memory, or external storage, configured to store data, instructions, or control information.
The term “external storage device” refers to a storage resource that is logically or physically separate from a main storage of the processor, including at least one of a network-attached storage device, a storage service provided over a communication network, or a secondary storage apparatus.
The term “electronic marketplace database” refers to a structured data store, such as a relational database, a key-value store, or another persistent data management system, that retains transaction target information, user information, transaction condition information, evaluation information, and related metadata for operating an electronic marketplace.
The term “transaction target information” refers to data identifying or representing items that can be subject to transactions in the electronic marketplace, including at least the concept information or the design information generated by the generative artificial intelligence model and related identification information and transaction condition information.
The term “user identification information” refers to information that uniquely or pseudo-uniquely identifies a user within the system, including at least one of a user identifier, an account identifier, or an authentication token.
The term “identification information” refers to a data element that identifies a storage location, a record, or an object within one or more storage devices or systems, and that is used to reference or retrieve the corresponding data.
The term “transaction condition information” refers to information defining conditions under which transaction target information may be transacted in the electronic marketplace, including at least one of price information, license conditions, availability conditions, or category information.
The term “communication interface” refers to hardware and software components that enable data exchange between the server and external devices, including at least one of network interface controllers, communication protocols, and communication stacks.
The term “ledger” refers to a data structure that records associations between unique identifiers and corresponding transaction target information, including at least one of a distributed ledger, a blockchain ledger, or an internal management ledger.
The term “distributed ledger” refers to a data storage mechanism in which transaction records are replicated and maintained across multiple computing nodes and updated according to a consensus mechanism, so that the records become tamper-resistant and verifiable.
The term “internal management ledger” refers to a data structure maintained within the server or within a controlled storage infrastructure, which records associations between unique identifiers and transaction target information without relying on a public or external distributed ledger.
The term “unique identifier” refers to an identifier that is generated such that it is unique within a predetermined namespace or system, and that is used to distinguish non-fungible token information corresponding to a specific item of transaction target information.
The term “cryptographic method” refers to a computational technique based on cryptography, including at least one of hash functions, digital signatures, encryption, or random number generation, used to generate or verify identifiers or to protect integrity of data.
The term “non-fungible token information” refers to information that represents a non-fungible digital token, including at least a unique identifier and associated metadata, which is bound to specific transaction target information to express uniqueness, ownership, or usage rights of the transaction target information.
The term “history information” refers to accumulated records that include at least the prompt sentences, generated concept information, generated design information, and associated parameters or contextual metadata, which are stored for subsequent analysis or control of the generative artificial intelligence model.
The term “input parameter” refers to a control value or configuration value supplied to the generative artificial intelligence model, including at least one of temperature, sampling parameters, model selection indicators, or weighting factors that influence generation behavior.
The term “prompt assistance information” refers to additional data derived from history information or other context that is combined with a prompt sentence or used to modify a prompt sentence, in order to adjust the input to the generative artificial intelligence model and improve generation accuracy or diversity.
The term “evaluation information” refers to information representing feedback regarding a transaction or a user, including at least one of a rating score, a textual comment, a timestamp, or an identifier of an evaluator and an evaluatee.
The term “reliability information” refers to a numerical value or categorical indicator calculated for each user based on evaluation information, transaction history, or other behavior metrics, and used by the server to represent a level of trust or reliability of the user.
The term “transaction fee information” refers to information relating to fees derived from transactions executed in the electronic marketplace, including at least a fee amount, a fee rate, and corresponding transaction identifiers.
The term “feature quantity” refers to one or more numerical or categorical values derived from evaluation information, transaction fee information, or other transaction-related data, which are used as input to statistical analysis processing or machine learning processing for fraudulent transaction detection.
The term “statistical analysis processing” refers to computer-implemented processing that applies statistical techniques, such as aggregation, distribution analysis, or anomaly detection based on statistical models, to feature quantities in order to evaluate the presence of irregular patterns.
The term “machine learning processing” refers to computer-implemented processing that applies a trained model, such as a classification model, a regression model, or an anomaly detection model, to feature quantities to determine whether a user or a transaction is suspected of being fraudulent.
The term “fraudulent transaction” refers to a transaction or a set of operations that violates predetermined rules, policies, or expected behavior patterns of the electronic marketplace, including at least one of false listings, manipulative evaluations, or illegitimate use of accounts or payment methods.
The term “search result” refers to data returned by the server in response to search conditions received from a terminal, including at least a list or a ranked set of transaction target information items that satisfy the search conditions.
The term “display order” refers to an order or ranking in which transaction target information or user information is arranged for presentation to the terminal, and which is determined based on at least one of relevance, reliability information, or other control criteria.
The term “display restriction processing” refers to control processing that limits, modifies, or suppresses the display of certain transaction target information or user information to terminals, based on predetermined rules or detection of suspicious or fraudulent behavior.
The term “transaction restriction processing” refers to control processing that limits, suspends, or conditions the ability of certain users or transaction target information to participate in transactions within the electronic marketplace, based on predetermined rules or detection of suspicious or fraudulent behavior.

In one embodiment, a server includes at least one processor, a main memory, a non-volatile storage device, and a communication interface connected via a hardware bus. The processor executes program modules stored in the non-volatile storage device and loaded into the main memory. The program modules include a marketplace management module, a generative AI interface module, a natural language processing module, a token management module, a fraud detection module, and a search and ranking module. The server communicates with a plurality of terminals operated by users via a packet-switched communication network.

A terminal is, for example, a personal computer, a mobile communication device, or a tablet device. The terminal executes a web browser or a native application that presents graphical user interfaces for entering a prompt sentence, for registering generated content as transaction target information, and for browsing and purchasing such information. A user operates the terminal to input data and to view outputs provided by the server.

The server uses a relational database system, such as an instance of a general-purpose relational database management system, as an electronic marketplace database. The server uses a key-value store or an object storage service, such as a generic cloud object storage, as an external storage device for storing large binary objects including images and other design files. The server optionally connects to a distributed ledger platform, such as a generic blockchain network, via a ledger client library implementing an interface to record non-fungible token information.

The server receives from a terminal a prompt sentence together with user identification information and stores both in the electronic marketplace database. The server uses the natural language processing module to tokenize the prompt sentence, perform part-of-speech tagging, and compute vector representations of the prompt sentence, for example using a transformer-based encoder architecture. The natural language processing module uses subword tokenization, builds an embedding sequence, and passes the sequence through multiple attention layers to generate a contextual representation of the prompt sentence suitable as input data to a generative AI model.

The server uses the generative AI interface module to provide the contextual representation to a generative AI model. In one embodiment, the generative AI model is an image generation network including a text encoder and a denoising diffusion model. The server provides the encoded representation as conditioning information to a diffusion process that iteratively denoises a latent variable, using a neural network composed of convolutional layers, attention layers, and normalization layers. The neural network adjusts intermediate activations based on the encoded prompt representation. In another embodiment, the generative AI model is an autoregressive transformer that outputs design information in the form of structured text or vector graphics instructions.

The server receives from the generative AI model output data representing concept information or design information. The server converts the output data into storage-ready data, such as raster image data or formatted textual data. For image outputs, the server applies image processing operations using a general-purpose image processing library, including color space conversion, resizing, and compression. For text outputs, the server normalizes character encoding and applies formatting rules to store the text in a structured form.

The server generates identification information that uniquely links each generated object to its storage location in the external storage device. The server writes the converted data to the external storage device and records in the electronic marketplace database a mapping between the identification information, the user identification information, and transaction condition information, such as pricing parameters and license attributes. The server thereby defines each piece of concept information or design information as transaction target information in the electronic marketplace.

The server records, as history information, the combination of the prompt sentence, the internal representation derived by the natural language processing module, the generative AI model configuration parameters (for example, diffusion step count, sampling temperature, classifier-free guidance weight), and the resulting concept information or design information.

The server stores this history information in a dedicated history table or data structure separate from the main product listing table. The server uses indexed storage and compressed vector formats to maintain this history information while reducing memory footprint and access time.

The server uses the history information to generate input parameters or prompt assistance information for subsequent invocations of the generative AI model. For example, the server computes a similarity measure between a newly received prompt sentence and stored prompt sentences using cosine similarity over embedding vectors. When the similarity exceeds a threshold, the server selects parameter sets that led to high evaluation scores or high reliability outcomes in past generations. The server modifies the new input by adjusting sampling temperature, guidance strength, or latent space initialization seed, and optionally appends auxiliary phrases to the prompt sentence. This adaptive parameter generation is not a simple automation of human tuning but an algorithmic process that exploits stored internal representations and evaluation feedback, thereby improving convergence of the generative process and reducing the number of iterations required to achieve high-quality outputs.

The server generates a unique identifier for each item of transaction target information by applying a cryptographic method, such as computing a cryptographic hash over the stored data and associated metadata. The server constructs a ledger record that includes at least the unique identifier, a hash value of the content, the user identification information, and relevant transaction condition information. The server writes this record either to an internal management ledger in the electronic marketplace database or, in another embodiment, to a distributed ledger where consensus among multiple nodes ensures immutability. The server associates this ledger record with non-fungible token information representing the uniqueness and ownership of the transaction target information.

The server uses this integrated structure, in which the electronic marketplace database, the external storage device, and the ledger share a consistent identifier, to maintain synchronized rights states and usage permissions. When the server updates a rights state or a license state, the server updates both the electronic marketplace database record and the corresponding ledger entry, thereby ensuring that ownership or usage rights are not inconsistently represented across different layers. This tight binding between data layers provides a technical improvement in state management compared with systems that maintain loosely coupled metadata.

The server analyzes evaluation information and transaction fee information to generate feature quantities for fraudulent transaction detection. The fraud detection module aggregates evaluation scores, variability measures, transaction frequencies, relative fee ratios, time-dependent patterns, and cross-user correlation features. The server constructs fixed-length feature vectors for each user or each transaction. The server supplies these feature vectors to a machine learning model, such as a gradient-boosted decision tree model or an anomaly detection neural network, which has been trained using supervised or semi-supervised learning.

During training, the server computes a loss function reflecting classification error or anomaly score deviation, and updates model parameters using gradient-based optimization. The server performs batch training or incremental training on designated training hardware that may include specialized accelerators. In deployment, the server applies the trained model in real-time or near real-time to incoming transactions. When the model outputs a score exceeding a threshold, the server marks the corresponding user or transaction as suspected of being fraudulent. The server then applies display restriction processing or transaction restriction processing by adjusting search result visibility, limiting listing capabilities, or temporarily suspending transaction execution.

The server uses the search and ranking module to retrieve transaction target information from the electronic marketplace database in response to requests from terminals. The server constructs query plans that incorporate not only textual matching of product names and descriptions, but also reliability information of sellers and ownership states of non-fungible tokens. The server applies ranking functions that weigh relevance scores derived from textual similarity with reliability scores derived from evaluation histories. The server counts only confirmed transactions recorded in the ledger when computing reliability, thereby avoiding manipulation by synthetic evaluations.

By integrating reliability and tokenized ownership data into the search and ranking algorithm, the server reduces the amount of data transmitted to terminals that is associated with low-trust or anomalous content and improves the probability that top-ranked results are both technically legitimate and valuable. This reduces network traffic and rendering overhead on terminals and increases the effectiveness of user interactions with the marketplace.

The server employs non-conventional data structures and processing orders to achieve these effects. For example, the server maintains a joint index keyed by user identification, token identifier, and content hash, enabling fast retrieval of consistent state across the database and the ledger. The server uses precomputed embedding caches for frequently used or highly similar prompt sentences, so that the natural language processing module does not repeatedly encode identical or near-identical text. This caching reduces redundant computation and decreases latency for generating concept information and design information.

The server further configures the generative AI model to use training procedures that include data augmentation tailored to marketplace usage. For example, the server trains the model using augmented prompt sentences that combine base descriptors (e.g., “cyberpunk city”) with structured style modifiers (e.g., “high contrast, neon, isometric”) and license tags. The server computes a loss function that encodes not only reconstruction or adversarial criteria, but also a term that encourages separation in latent space between designs associated with different license categories. By doing so, the model learns representations that the server can reliably interpret for enforcing licensing conditions and rights states.

A user operates a terminal to input a prompt sentence in natural language. Examples of the prompt sentence include:

“Generate a cyberpunk-style T-shirt design with neon city lights and a dark background.”

“Create a minimalist T-shirt design with a single mountain silhouette and a rising sun in pastel colors.”

“Generate an isometric illustration of a digital marketplace with users trading AI-generated designs.”

“Explain step by step how a user can register a design generated by a generative AI model as a product in the marketplace.”

The server processes each prompt sentence according to the described pipeline. For prompts that are intended to generate visual designs, the server selects an image-oriented generative AI model and applies image-specific parameter tuning derived from history information. For prompts that are intended to generate explanatory text, the server selects a text-oriented generative AI model, such as a transformer decoder, and uses a different set of generation parameters and stopping conditions. The server distinguishes between these use cases via classification of the prompt sentence using the natural language processing function, which outputs a content type prediction based on learned patterns in the embedding space.

The server thereby performs processing that is not merely a generic automation of human conceptual work. The server coordinates a set of specialized hardware and software modules, leverages structured history information for adaptive control of generative AI model parameters, integrates cryptographic token management with marketplace state, and uses machine learning-based fraud detection to influence core data retrieval and presentation. This architecture improves computer-implemented processing in terms of generation accuracy, computational efficiency, consistency of state across storage layers, and robustness against fraudulent manipulation.

Alternative embodiments are possible. In one embodiment, the server uses a different neural network architecture, such as a generative adversarial network with a convolutional generator and discriminator, instead of a diffusion model. In another embodiment, the server employs a recurrent neural network-based language model or a hybrid model combining convolutional and attention layers. In yet another embodiment, the server uses a local ledger implementation instead of a public distributed ledger, while still applying cryptographic hashing and signed records to maintain integrity.

In all such embodiments, the server, the terminal, and the user cooperate as described, and the technical configuration of the modules, data structures, and algorithms allows other practitioners to implement the claimed system by preparing equivalent processing units, memory, network interfaces, databases, and trained generative AI models configured according to the described structures and operations.

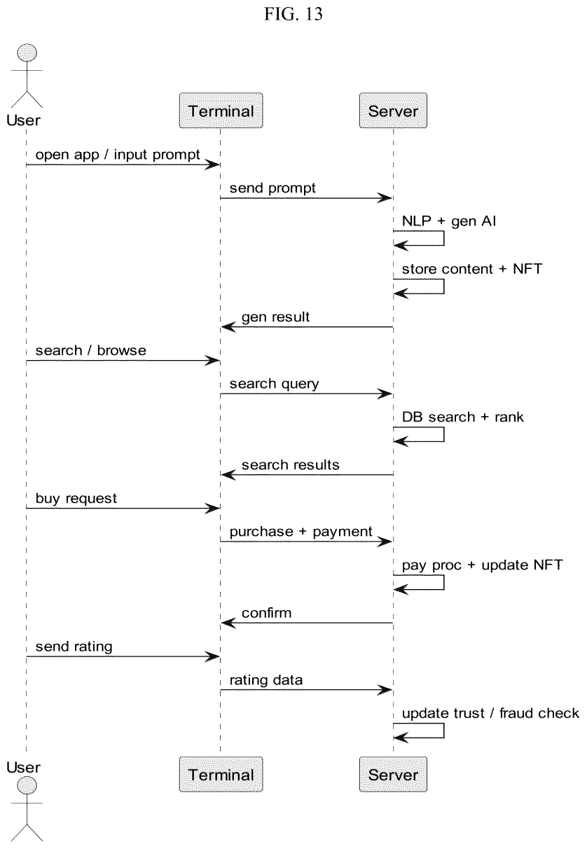

The following describes the processing flow using FIG. 13.

### Step 1:

User operates the terminal to access the marketplace application and to input a prompt sentence.

User launches a web browser or a native application on the terminal and opens a screen for creating new concept information or design information. User types a prompt sentence, such as “Generate a cyberpunk-style T-shirt design with neon city lights and a dark background,” and confirms the input together with optional parameters (for example, desired resolution or style strength).

Input: natural language prompt sentence and optional generation parameters entered by the user.

Output: HTTP request data including the prompt sentence, user identification information, and generation parameters, transmitted from the terminal to the server.

### Step 2:

Terminal sends the prompt sentence and user identification information to the server.

Terminal packages the prompt sentence, user identification information, and generation parameters into a request message, for example a JSON payload, and sends the message to a designated API endpoint of the server via a secure communication protocol. Terminal attaches session tokens or authentication headers to identify the user.

Input: user-entered prompt sentence, user identification information, and generation parameters held in the terminal's application layer.

Output: structured request message delivered over the network to the server's communication interface.

### Step 3:

Server receives and records the prompt sentence as history information.

Server accepts the incoming request via a communication interface, validates the authentication headers, and extracts the prompt sentence and user identification information from the request body. Server stores these elements in a marketplace database as a new history record, including a timestamp and a unique history identifier.

Input: structured request message containing prompt sentence, user identification information, and generation parameters.

Output: stored history record in the database, including the prompt sentence, user identification, parameters, and a newly assigned history identifier.

### Step 4:

Server performs natural language processing on the prompt sentence.

Server supplies the prompt sentence to a natural language processing module that tokenizes the sentence into subword units, maps each token to an embedding vector, and processes the sequence through multiple attention layers of a transformer encoder. Server computes contextual embeddings representing semantic features of the prompt sentence and aggregates these embeddings into a fixed-length representation to be used as input data for a generative AI model.

Input: raw text prompt sentence retrieved from the history record.

Output: numerical vector representations (contextual embeddings) and derived input data structure for the generative AI model.

### Step 5:

Server generates adaptive parameters or prompt assistance information from history information.

Server queries the history store to retrieve past prompt sentences and associated evaluation scores or reliability information. Server computes similarity metrics between the current prompt embedding and stored embeddings, selects highly similar records, and extracts successful parameter configurations. Server derives adjusted generation parameters or auxiliary phrases, forming prompt assistance information that will influence the behavior of the generative AI model.

Input: current prompt embedding, stored history embeddings, and past parameter-performance pairs.

Output: updated generation parameter set and optional auxiliary textual additions that will be combined with the original prompt or supplied as conditioning data.

### Step 6:

Server calls the generative AI model to generate concept information or design information.

Server constructs a model input object that includes the contextual embeddings, the adaptive parameters, and optionally the prompt assistance information. Server forwards this object to a generative AI model execution environment, such as an image generation network or a text generation network, running on specialized hardware. Inside the model, the server drives a sequence of matrix multiplications, non-linear activations, and attention computations to propagate the input through the network. In a diffusion-based image model, the server iteratively denoises a latent tensor conditioned on the prompt representation until a final latent image representation is obtained.

Input: contextual embeddings of the prompt sentence and adapted generation parameters.

Output: raw model output representing either concept information (structured text) or design information (latent image or directly decoded pixel data).

### Step 7:

Server converts model output into storage-ready data and stores it in external storage.

Server decodes latent representations into actual image pixel arrays or parses structured text tokens into human-readable text. Server applies post-processing, such as resizing and compression for images, or formatting and encoding normalization for text. Server writes the resulting file or text data to an external storage device and receives a storage location identifier, such as a path or a uniform resource locator.

Input: raw output tensors or token sequences produced by the generative AI model.

Output: formatted storage-ready content (image file or text document) and a storage location identifier in the external storage device.

### Step 8:

Server registers the generated content as transaction target information in the marketplace database.

Server prepares a product record containing the storage location identifier, user identification information, transaction condition information, and metadata such as title and category.

Server inserts this record into an electronic marketplace database and assigns a unique product identifier. Server associates the previously created history identifier with this product identifier to maintain a link between the prompt sentence and the generated content.

Input: storage location identifier, user identification information, transaction condition information, and metadata.

Output: persistent product record in the marketplace database, including a product identifier linked to the generated content and history information.

### Step 9:

Server generates a cryptographic unique identifier and records non-fungible token information.

Server computes a hash value over the stored content and essential metadata to obtain a content fingerprint. Server combines this fingerprint with a random or sequential component and generates a unique identifier by applying a cryptographic algorithm. Server writes a ledger record that maps the unique identifier to the product identifier, user identification information, and hash value, thereby forming non-fungible token information. In a distributed ledger embodiment, server transmits this record to a ledger node for consensus and confirmation.

Input: product identifier, content hash value, user identification information, and cryptographic parameters.

Output: non-fungible token information, including a unique identifier and a ledger record associated with the product.

### Step 10:

User uses the terminal to browse and search transaction target information.

User operates the terminal to open a marketplace browsing interface, inputs search keywords or applies filters, and submits a search request. Terminal packages these conditions into a query message and sends the message to the server.

Input: user-entered search conditions on the terminal.

Output: structured search query transmitted from the terminal to the server.

### Step 11:

Server searches the marketplace database and ranks transaction target information.

Server accepts the search query and constructs a database query that matches keywords against product names and descriptions. Server simultaneously retrieves reliability information of associated users and status of non-fungible token information. Server computes a relevance score for each candidate based on keyword matching and combines this with a reliability score derived from evaluation information. Server sorts the candidates according to a ranking function that weights these scores and may demote items associated with suspected fraudulent activity.

Input: search query conditions, product records, user reliability values, and token state data.

Output: ordered list of transaction target information items, each including a product identifier and summary metadata.

### Step 12:

Terminal receives and displays search results to the user.

Terminal receives the ordered list from the server and constructs a graphical representation such as a list or grid. Terminal fetches thumbnail images and summary text for each item and renders them on the display. User can scroll, select items, or refine filters based on this list.

Input: ordered list of products and associated summary metadata from the server.

Output: rendered search results on the terminal screen, enabling user interaction.

### Step 13:

User selects a product and initiates a purchase request.

User views details of a selected product on the terminal, confirms the desire to purchase, and enters payment information or selects a stored payment method. User triggers a purchase action in the interface.

Input: user's product selection and payment authorization input.

Output: purchase request message from the terminal, containing product identifier, user identification, and payment token or payment data, sent to the server.

### Step 14:

Server processes payment and updates transaction states.

Server receives the purchase request, validates availability of the product, and calculates a transaction amount and a corresponding transaction fee. Server forwards payment information to a payment processing system and receives an approval or rejection. Upon approval, server writes an order record containing buyer and seller identifiers, transaction amount, fee amount, and timestamps. Server updates the rights state or license state in the product record and, where applicable, writes an ownership transfer or license record into the ledger by associating the non-fungible token information with the buyer.

Input: purchase request data including product identifier, buyer identification, and payment token, and current product state.

Output: order record in the database, updated product state, updated ledger entry reflecting ownership or license, and confirmation status returned to the terminal.

### Step 15:

Server records evaluation information and updates reliability information.

After a transaction completes, server receives evaluation information from the terminal, including rating scores and comments from the buyer or seller. Server stores each evaluation as a record linked to the corresponding order and users. Server computes updated reliability information by aggregating scores and applying weightings that consider transaction volume, recency, and variance. Server writes updated reliability values into user records.

Input: evaluation data linked to specific orders and users, and existing reliability statistics.

Output: new evaluation records and recalculated reliability values in the marketplace database.

### Step 16:

Server periodically analyzes transaction fee information and evaluation information for fraud detection.

Server aggregates evaluation information, transaction fee records, and behavioral logs into feature vectors for each user or for each transaction. Server applies statistical analysis or a trained machine learning model to these feature vectors to obtain an anomaly score or classification result. When the result indicates a potential fraudulent transaction or user, server updates internal flags and modifies visibility and capabilities for affected entities, such as restricting product listing or lowering ranking priority.

Input: historical evaluation information, transaction fee information, behavioral logs, and machine learning model parameters.

Output: fraud suspicion indicators, updated control flags in user and product records, and modified search and display behavior for subsequent queries.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computing systems that provide marketplaces for digital content or generative AI outputs generally treat a user's prompt sentence as a simple text payload and process it in isolation from user-specific context. In such systems, a server typically forwards the raw prompt sentence to a generative AI model, receives generated content, and stores that content in a database. The server may then expose the content via a basic listing function and rely on an external payment service for settlement. However, this architecture leaves multiple technical problems unresolved in the context of computer-implemented marketplaces that rely on generative AI models.

First, conventional systems lack a unified, processor-level mechanism to integrate emotion analysis with prompt sentence processing and generative AI invocation. Emotion inference, if present at all, is usually implemented as a separate analytics feature that is not tightly coupled with prompt expansion, model input formation, or downstream product registration. As a result, the server cannot systematically generate generation instruction information that conditions the generative AI model on both the prompt sentence and dynamically inferred emotion information. This leads to sub-optimal utilization of computation resources in the model, and prevents the system from producing outputs that are adaptively tailored at the infrastructure level.
Second, conventional systems do not provide an integrated data processing pipeline that transforms AI-generated concept or design information into structured product information, updates search indices in real time, and atomically links this information to non-fungible tokens on a distributed ledger network. Marketplace servers typically handle content storage, search indexing, and blockchain interactions as separate, loosely coupled subsystems. This fragmentation causes redundant data transformations, inconsistent state between the marketplace database and the distributed ledger, and increased latency, thus degrading the overall performance and reliability of the computer system.
Third, conventional marketplaces lack a processor-implemented mechanism that dynamically determines recommendation order and price information based on both emotion information and behavior history information while simultaneously coordinating settlement processing and token ownership updates. Emotion-aware recommendation engines may exist as standalone services, but they are not structurally integrated with transaction data handling, fee calculation, and non-fungible token holder updates. This separation leads to duplicated logging, inefficient joins across multiple data stores, increased memory consumption, and complex error handling, which collectively reduce the scalability and robustness of the platform.
Fourth, existing systems do not efficiently aggregate transaction data and fee data at the processor level to generate period-based statistical information in a form directly consumable by a management display apparatus. Operators are forced to rely on external reporting tools that extract and recompute statistics from raw logs, which introduces additional I/O overhead, inconsistent aggregation logic, and delays in obtaining accurate operational metrics. This impacts the ability of the computer system to self-monitor and adjust internal parameters (for example, pricing rules or model invocation thresholds) in near real time.
Accordingly, there is a need for a computer-implemented system in which a processor coordinates, within a single coherent architecture: (i) reception and storage of prompt sentences, (ii) estimation and attachment of emotion information, (iii) generation of expanded generation instruction information for a generative AI model, (iv) post-processing and structuring of model outputs as product information, (v) synchronized indexing and registration on an electronic transaction platform, (vi) issuance and update of non-fungible tokens on a distributed ledger network, (vii) emotion- and behavior-aware recommendation and dynamic pricing, (viii) integrated settlement processing and fee calculation, and (ix) automatic generation of period-based statistical information. By addressing these issues at the processor and data-flow level, the invention aims to improve the functioning of the underlying computer system itself, including its data consistency, processing efficiency, scalability, and robustness in operating a generative-AI-based electronic marketplace.

The specific processing by the specific processing unit 290 of the data processing device 12 in Application Example 2 is realized by the following means.

The present invention provides a server comprising a processor configured to receive, from a terminal operated by a user, a prompt sentence input by the user; to estimate emotion information based on the prompt sentence and attribute information related to the user and to store the emotion information in association with the prompt sentence in a storage apparatus; to generate generation instruction information by expanding the prompt sentence based on the emotion information and to input the generation instruction information to a generative AI model executed on a computation resource; to obtain concept information or design information generated by the generative AI model based on the generation instruction information and to perform, by program control, content filtering processing and formatting processing on the concept information or the design information so as to generate normalized content data; to structure the normalized content data as product information having a predefined schema and to register the product information in an information storage device of an electronic transaction platform while updating a search index stored in a search data structure; to generate non-substitutable identification information corresponding to the product information by calling a smart contract on a distributed ledger network, to issue a non-fungible token for identifying the product information, and to store an identifier of the non-fungible token in association with the product information within the storage apparatus; to extract the product information in response to a browsing request or a search request from another user, to determine at least one of a recommendation order and price information dynamically based on at least the emotion information and behavior history information of a user stored in a log data store, and to transmit information including the determined at least one of the recommendation order and the price information to the terminal via a communication interface; to receive a purchase request from the other user, to execute settlement processing by using an external settlement processing device through a communication protocol, to generate transaction data based on a result of the settlement processing, to calculate fee information based on the transaction data by executing arithmetic processing, and to store the transaction data and the fee information in the storage apparatus; to update holder information of the non-fungible token on the distributed ledger network based on the transaction data by invoking a function of the smart contract, and to provide, to the terminal, right-to-use information and content acquisition information for a purchaser based on the updated holder information; and to aggregate the transaction data stored in the storage apparatus to generate, by batch or stream processing, transaction statistical information and fee statistical information for each period and to store the statistical information in a format outputtable to a management display apparatus. This enables the computer system to process prompt sentences, emotion information, generative AI outputs, marketplace data, settlement data, and distributed ledger token data within a unified processor-controlled pipeline that reduces data redundancy, improves state consistency between the electronic transaction platform and the distributed ledger network, enhances the efficiency and responsiveness of recommendation and pricing computations, and provides timely operational statistics, thereby improving the overall performance and reliability of the underlying computing infrastructure used to operate a generative-AI-based electronic marketplace.

The term “processor” refers to a hardware or virtual computation element, such as a central processing unit, graphics processing unit, or programmable logic device, that executes instructions of a program to perform data processing operations specified herein.

The term “terminal” refers to an information processing apparatus operated by a user, such as a mobile device, a personal computer, or a head-mounted display, that transmits input data to a server and receives output data from the server via a communication network.

The term “user” refers to a human operator who interacts with the terminal to input data, including prompt sentences and transaction instructions, and who receives content and marketplace information generated by the system.

The term “prompt sentence” refers to textual information input by a user and supplied to a generative AI model as an instruction or request for generating concept information, design information, or other content.

The term “attribute information” refers to information related to a user, such as profile data, usage history, or preference data, that is stored by the system and can be used to estimate emotion information or to personalize processing.

The term “emotion information” refers to data representing an inferred emotional state of a user, such as joy, sadness, surprise, or other affective categories, optionally including confidence values or intensity values, estimated based on input data associated with the user.

The term “generation instruction information” refers to information generated by the processor by expanding or transforming a prompt sentence, optionally including emotion information and additional context, which is provided as an input to a generative AI model to control generation behavior.

The term “generative AI model” refers to a machine learning model, such as a neural network model, that processes a prompt sentence or generation instruction information and generates content including concept information, design information, text, images, audio, or other data.

The term “concept information” refers to generated abstract or descriptive data that express an idea, plan, or structure, which can serve as the basis for a product or service within the electronic transaction platform.

The term “design information” refers to generated content describing or representing a visual, structural, or aesthetic arrangement, such as an image, layout, or style specification, suitable for use as a product or asset within the electronic transaction platform.

The term “content filtering processing” refers to processing performed by the processor on generated content to remove, replace, or modify portions of the content according to predetermined rules, such as safety policies, format constraints, or quality criteria.

The term “formatting processing” refers to processing performed by the processor to transform generated content into a normalized or structured representation, including operations such as text formatting, metadata assignment, or media conversion.

The term “normalized content data” refers to content that has undergone content filtering processing and formatting processing and that conforms to a predefined data format or schema used internally by the system.

The term “product information” refers to structured data representing a tradable item in the electronic transaction platform, including at least references to concept information or design information, identification data, pricing data, and descriptive metadata.

The term “electronic transaction platform” refers to a server-side system that manages listing, searching, recommending, purchasing, and delivering digital or virtual items by storing and processing product information and transaction data via an electronic communication network.

The term “information storage device” refers to a storage subsystem, such as a database system or a file storage system, that stores product information, prompt sentences, transaction data, and other data used by the electronic transaction platform.

The term “search index” refers to a data structure, such as an inverted index or key-value index, that allows the processor to retrieve product information efficiently in response to search conditions including keywords and filters.

The term “distributed ledger network” refers to a network of computing nodes that collectively maintain a replicated and synchronized ledger of transactions, using a consensus mechanism to ensure integrity and immutability of recorded data.

The term “smart contract” refers to a program stored and executed on a distributed ledger network that defines operations related to data records, including issuance, transfer, and management of non-fungible tokens.

The term “non-substitutable identification information” refers to information that uniquely identifies product information in association with a token on a distributed ledger network, such that it cannot be interchanged with identification information of another product.

The term “non-fungible token” refers to a token recorded on a distributed ledger network, which represents unique ownership or rights to specific digital or virtual content, and which is not interchangeable on a one-to-one basis with other tokens.

The term “identifier of the non-fungible token” refers to data, such as a token ID or address, that uniquely specifies a particular non-fungible token within the distributed ledger network.

The term “browsing request” refers to a request transmitted from a terminal to the server for displaying product information, which may include parameters such as a product identifier, category, or display conditions.

The term “search request” refers to a request transmitted from a terminal to the server that includes search conditions, such as keywords, categories, or filters, to retrieve matching product information from the search index or storage.

The term “behavior history information” refers to data representing historical actions of a user in the system, including browsing, searching, clicking, and purchasing behaviors, which is stored and used for recommendation and analysis.

The term “recommendation order” refers to an order or ranking assigned to product information by the processor based on predetermined criteria, including emotion information and behavior history information, for presentation to a user.

The term “price information” refers to data indicating a monetary amount or other consideration required for acquiring product information or associated rights, which may be dynamically determined or adjusted by the processor.

The term “purchase request” refers to data transmitted from a terminal to the server, indicating a user's intent to acquire a product and including at least a product identifier and payment-related information.

The term “external settlement processing device” refers to a system or service external to the server that performs financial transaction processing, such as authorization and capture of payments, in response to settlement requests from the server.

The term “settlement processing” refers to processing that initiates, authorizes, and completes a financial transaction for a purchase request, including communication between the server and an external settlement processing device.

The term “transaction data” refers to data representing details of an executed or attempted transaction, including at least identifiers of the product, buyer, seller, amounts, status, and timestamps.

The term “fee information” refers to data representing a calculated fee amount, derived from transaction data, that is associated with a transaction as remuneration to an operator of the electronic transaction platform or related service.

The term “holder information” refers to data indicating an entity, such as a user or account, that is recognized as the owner or controller of a non-fungible token on the distributed ledger network.

The term “right-to-use information” refers to data indicating usage rights or access permissions granted to a purchaser with respect to content associated with product information and a non-fungible token.

The term “content acquisition information” refers to data, such as access URLs, tokens, or decryption keys, that enables a purchaser to obtain or access content associated with product information.

The term “log data store” refers to a storage facility that records event data, including user actions and system events, which can be analyzed to infer behavior history information or emotion information.

The term “management display apparatus” refers to an information processing apparatus used by an operator or administrator, configured to display operational information, such as statistical information, regarding the electronic transaction platform.

The term “transaction statistical information” refers to aggregated data derived from multiple transaction records over a time period, such as counts, totals, or averages of transactions, generated for monitoring or analysis.

The term “fee statistical information” refers to aggregated data derived from multiple fee records over a time period, such as total fee amounts or distributions, generated for monitoring or analysis.

The term “period” refers to a time interval, such as a day, week, month, or other definable unit of time, over which transaction data and fee data are aggregated to generate statistical information.

In one embodiment, a server implements the claimed system by executing a computer program stored in a non-transitory storage apparatus. The server comprises at least one processor, a main memory, a network interface, and a storage subsystem that includes a relational database, a document database, and a log data store. The server communicates with a plurality of terminals over a network such as the Internet. Each terminal is, for example, a smartphone, a tablet computer, a notebook computer, or a head-mounted display. Each user operates a terminal to input a prompt sentence, to review generated content, and to perform marketplace operations.

The server executes an application layer implemented by server-side software such as a web application framework and a set of microservices. In one concrete configuration, the server uses an application framework implemented in a general-purpose programming language and runs behind an HTTP server. The server stores structured data (for example, product information and transaction data) in a relational database management system and uses a document-oriented database or a key-value store for prompt sentences and model outputs.

The server uses an object storage system to store large binary data such as images and media files. The server also uses a dedicated search engine to maintain search indices of product information.

The terminal executes a client application implemented as a native mobile application, a cross-platform application, or a web browser application. The terminal comprises a processor, memory, a communication interface, an input interface such as a touch screen, keyboard, microphone, and camera, and a display unit. The terminal application formats user operations into structured requests and transmits them to the server via HTTPS, and renders server responses on the display as graphical user interface components.

The server processes a prompt sentence by means of a prompt handling module. The prompt handling module receives, via the network interface, a prompt sentence entered by a user on a terminal. The prompt sentence is plain text in a natural language. Examples of the prompt sentence include:

“Please propose a concept for a next-generation eco-friendly car.”

“Generate a story set in a medieval fantasy world where a young wizard rebuilds a lost kingdom.”

“Today I want a surprising design.”

“Please generate a new T-shirt design and issue an NFT corresponding to that design.”

“I want to relax.”

The server stores each received prompt sentence in a prompt table in the document database, together with a unique prompt identifier, a user identifier, timestamps, and attribute information related to the user. The server normalizes the prompt sentence by performing tokenization, Unicode normalization, and removal of control characters. The server also stores a hash value of the normalized prompt sentence as an index key, which accelerates duplicate detection and retrieval. This specific data structure reduces memory footprint and facilitates deduplication when many similar prompt sentences are processed, thereby improving storage efficiency and read performance.

The server estimates emotion information using an emotion analysis module. The emotion analysis module obtains one or more of the prompt sentence text, optional voice input captured by the terminal microphone, and image data captured by the terminal camera. The server extracts feature vectors from the text by applying a natural language processing pipeline. The pipeline includes tokenization, subword encoding, embedding lookup, and transformation through a pre-trained language encoder model. For audio, the server computes a spectrogram or mel-frequency cepstral coefficients and feeds the time-frequency representation into a recurrent neural network or convolutional neural network. For image data, the server detects a face region and computes facial landmarks and pixel-level features using a convolutional neural network.

The server then feeds these feature vectors into an emotion classification model. In one embodiment, the emotion classification model is a neural network that comprises an input layer receiving concatenated feature vectors, several fully connected layers with non-linear activation functions, and an output layer that produces a probability distribution over discrete emotion categories such as joy, sadness, anger, fear, and surprise. The server computes a loss function, such as cross-entropy loss, during training and updates the model weights using backpropagation and an optimization algorithm such as stochastic gradient descent with momentum or an adaptive learning-rate optimizer. The server may perform data augmentation during training by perturbing text, adding noise to audio, or performing random crops and flips on images to improve generalization.

At inference time, the server executes the trained model to output emotion information, including a dominant emotion label and associated confidence values. The server stores the emotion information together with the prompt identifier in an emotion table. By storing emotion information as a compact fixed-length vector and a categorical label, the server enables efficient joins between prompt sentences and emotion information using indexed foreign keys. This architecture reduces the number of database reads compared to re-computing emotion information on demand, thereby improving response times for subsequent processing.

The server generates generation instruction information using a prompt expansion module.

The prompt expansion module constructs an expanded instruction sequence that includes the original prompt sentence and structured annotations based on emotion information and user attribute information. For example, when the user emotion is “joy,” the server generates an instruction such as:

“The user currently feels joyful. Based on the following prompt sentence, generate a bright and positive design concept: [prompt sentence].”

When the user emotion is “surprise,” the server generates an instruction such as:

“The user currently feels a sense of surprise and desires an unexpected experience. Based on the following prompt sentence, generate an innovative and surprising visual design: [prompt sentence].”

The server encodes the instruction in a textual format compatible with a generative AI model interface. The server also attaches generation parameters such as temperature, maximum output length, nucleus sampling probability, and top-k values. These parameters are stored in a generation configuration table, keyed by a model identifier and content type, which allows the server to retrieve commonly used parameter sets with constant-time lookup.

The server invokes a generative AI model via a model invocation module. In one embodiment, the generative AI model is a transformer-based neural network that has been trained on large corpora of text and/or images. The model comprises an encoder-decoder or decoder-only architecture with multiple attention layers, feed-forward layers, and layer normalization. The server tokenizes the generation instruction information into a sequence of discrete tokens using a defined vocabulary. The server then sends the token sequence and generation parameters to an inference engine, which may be hosted on the same server, on a dedicated inference server, or on an external AI service.

The generative AI model processes the token sequence by computing attention scores between tokens, applying linear transformations, and repeatedly predicting the next token distribution, sampling or selecting the next token according to the configured decoding strategy. For image or design outputs, a diffusion-based model can be used. In this case, the server encodes the prompt into a latent space, iteratively refines a noise vector using a denoising network, and decodes the final latent representation into an image.

The server receives generated content as a token sequence or an encoded media representation. For textual content, the server decodes the tokens into a string and performs post-processing such as trimming of incomplete sentences, insertion of line breaks, and normalization of white space. For images, the server decodes the output into a raster image, optionally resizes or compresses the image, and stores it in object storage.

The server performs content filtering processing using a content moderation module. The content moderation module may apply rule-based filters, pattern matching, or an additional classifier network to detect prohibited or unsafe content. The server applies replacement or removal operations to segments that match filters, and flags content as suitable or unsuitable for listing. By performing filtering before storing the content as product information, the server prevents propagation of unsafe content through the indexing and marketplace layers, improving system reliability and reducing the need for costly downstream corrections.

The server executes formatting processing and normalization using a content formatting module. The module transforms the generated content into a normalized content data structure. For text, the server generates a structured representation that contains paragraphs, headings, and summary fields. For images, the server generates metadata including resolution, color space, and content tags. The normalized content data conforms to a schema stored in a schema table. Use of a schema allows the server to store and query heterogeneous contents using a common product information format, improving query efficiency and simplifying application logic.

The server structures the normalized content data as product information via a product registration module. The product registration module constructs a product record that includes references to normalized content data, the original prompt sentence, the user who requested the content, and derived attributes such as category, tags, and language. The server assigns a unique product identifier. The server stores the product record in the relational database, mapping columns to fields such as product identifier, content reference, owner identifier, base price, and status. The server also registers the product in the search index by generating index documents that contain searchable fields and ranking signals.

The server generates non-substitutable identification information via a token management module. The token management module calls a smart contract deployed on a distributed ledger network. The server constructs a metadata payload for the product, including at least a content reference, a prompt identifier, and optional attributes such as creation time and generative AI model identifier. The server submits a transaction to the distributed ledger network to invoke a minting or registration function of the smart contract. The smart contract assigns a unique token identifier to the product and records the association on the ledger. The server records the token identifier, contract address, and ledger transaction identifier in a token table and links them to the corresponding product record. By linking product information to non-fungible tokens at the storage level, the server ensures a consistent mapping between marketplace data and ledger data, which reduces the risk of mismatch or duplication and improves data integrity.

The server computes recommendation order and price information using a recommendation and pricing module. The recommendation module uses behavior history information stored in a log data store, which contains records of user interactions such as product views, search queries, clicks, purchases, and time spent on pages. The server aggregates these logs into user profiles and product statistics. The server applies a hybrid algorithm that combines collaborative filtering with content-based ranking and emotion-aware weighting. For example, the server can compute a base relevance score based on similarity between a user's past behavior vector and candidate product vectors, then adjust the score by adding a term proportional to the similarity between the user's current emotion vector and the product's historical emotion affinity vector.

The pricing module computes dynamic price information by applying deterministic rules or learned functions to base prices, taking into account current emotion information, demand metrics, and system constraints. For example, the server may increase a base price by a fixed percentage when the emotion information indicates high excitement and demand for a product type, while ensuring that price changes remain within predefined limits to avoid instability. These computations are executed by the processor using numerical operations, and the results are cached in a price cache for fast retrieval.

By integrating recommendation and pricing computations directly with emotion information and behavior history information in a shared data model, the server reduces the number of remote calls and data copies that would otherwise be needed if these functions were separate services. This architectural integration reduces latency for recommendation responses and decreases the load on the database and network subsystems, which in turn improves scalability of the system.

The server processes settlement and transaction data using a transaction management module. The transaction management module interacts with an external settlement processing device by sending payment requests and receiving payment results. The server constructs structured transaction data that includes references to product information, buyer and seller identifiers, amounts, and timestamps. The server computes fee information by applying arithmetic operations to the transaction amount and a fee rate stored in a configuration table. The server stores transaction data and fee information in a transaction table.

The server updates token holder information through the token management module. When a transaction representing a purchase is completed, the server calls a transfer function of the smart contract on the distributed ledger network to update the owner of the non-fungible token associated with the product. The distributed ledger records the transferred ownership, and the server retrieves or receives confirmation of the update, then updates local holder information in the token table. The server generates right-to-use information and content acquisition information for the new holder, including secure access tokens or signed URLs that grant access to the purchased content. The server transmits this information to the terminal, which displays status messages and allows the user to retrieve the content.

The server aggregates transaction data and fee data using an analytics module. The analytics module executes batch or near-real-time aggregation processes that compute transaction statistical information and fee statistical information per time period. The module uses group-by and aggregation operations on indexed columns in the transaction table to compute metrics such as total volume, average price, and fee totals. The server stores the aggregated results in a statistics table, which is structured for efficient retrieval by a management display apparatus. This arrangement reduces the need for external reporting tools and avoids repeated scanning of raw logs, thereby lowering computation cost and I/O load.

The above architecture provides specific technical effects beyond automation of human tasks.

The server uses specialized data structures—such as normalized content records, prompt-emotion associations, token mappings, and indexed logs—to reduce redundancy and improve query performance. The integration of emotion inference, prompt expansion, generative AI invocation, marketplace indexing, token issuance, settlement, and analytics into a unified processor-controlled pipeline reduces the number of serialization and deserialization steps, lowers network round-trips between subsystems, and improves cache locality. These characteristics lead to faster end-to-end response times and more efficient use of CPU and memory resources.

Additionally, the use of machine learning models with well-defined architectures and training methods improves accuracy and stability of emotion estimation and content generation compared to simple rule-based methods. The server trains the emotion analysis model and generative AI model using large training datasets and applies techniques such as regularization, scheduled learning rates, and validation monitoring to maintain performance. Because the models operate on high-dimensional feature vectors and complex attention patterns that cannot be replicated efficiently by manual rules, the system realizes functional behaviors and performance levels that are qualitatively different from human manual operation.
Furthermore, the server controls the flow of data among hardware components and external devices, including terminals, storage subsystems, and distributed ledger nodes. For example, by scheduling model inference on dedicated computation resources and by batching interactions with the distributed ledger, the server can reduce contention on the network and improve throughput of token operations. The server's internal modules are arranged to reuse intermediate representations, avoid unnecessary copying of large media objects, and coordinate data access patterns with the underlying storage engines. These implementation details result in reduced disk I/O, reduced network bandwidth usage, and improved overall stability under high load.
In alternative embodiments, the server can use different types of generative AI models, such as sequence-to-sequence models, variational autoencoders, or other deep learning architectures. The server can also adapt the structure of generation instruction information for specific content types, such as audio tracks, three-dimensional models, or interactive experiences. The emotion analysis module may be replaced or augmented by rule-based or hybrid models, while still storing emotion information in association with prompt sentences and using it to condition generative outputs.
In another embodiment, part of the processing may be offloaded to the terminal. For example, the terminal may perform initial audio preprocessing or facial detection to reduce the amount of raw data transmitted to the server, thereby reducing communication load. However, the core coordination functions, including association of prompt sentences with emotion information, formation of generation instruction information, product structuring, search indexing, token management, settlement coordination, and statistics generation, remain executed by the server as recited in the claims.
The described embodiments show how the server, the terminal, and the user cooperate to implement a system in which prompt sentences, emotion information, and generative AI outputs are tightly integrated into a technically improved electronic transaction platform, with concrete data structures, processing modules, and neural network architectures that enhance processing speed, accuracy, data integrity, and resource utilization.

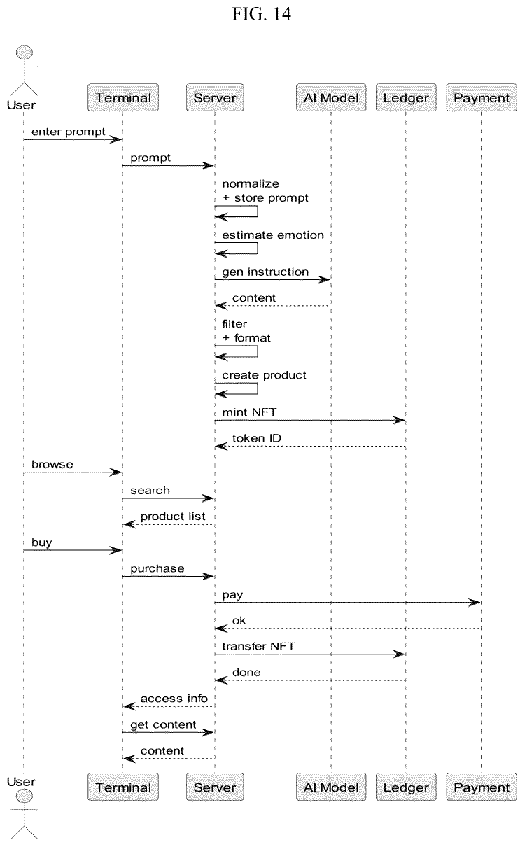

The following describes the processing flow using FIG. 14.

### Step 1:

User operates the terminal to input a prompt sentence and user attributes.

User opens an application on the terminal and types a prompt sentence in a text input field, for example, “Please propose a concept for a next-generation eco-friendly car.” User may also adjust settings such as desired content type (text, image) or length. Terminal captures the prompt sentence and user identifier as input, validates that the text is non-empty and within a maximum length, and constructs a request object that includes the prompt sentence, user identifier, device identifier, and timestamp. Terminal then transmits this request to the server via HTTPS. The output of this step is a structured request message containing the prompt sentence and user attributes, delivered from the terminal to the server.

### Step 2:

Server parses and normalizes the received prompt sentence.

Server receives the HTTPS request as input and parses the message body to extract the prompt sentence, user identifier, and metadata. Server applies text normalization, including Unicode normalization, removal of control characters, and lowercasing if required by downstream models. Server then tokenizes the prompt sentence into tokens and computes a hash value of the normalized text using a hashing function. Based on this hash, server checks a prompt store to detect whether an identical prompt has been processed before. Server writes a new prompt record to a prompt table with a unique prompt ID, user ID, normalized prompt text, hash, and timestamps. The output of this step is a stored prompt record with a prompt ID and normalized text available for subsequent processing.

### Step 3:

Server estimates emotion information associated with the prompt sentence.

Server uses the stored prompt record as input, together with optional auxiliary data such as prior user behavior and any audio or image data forwarded by the terminal. Server converts the normalized text into an embedding vector using a language encoder, and optionally computes additional feature vectors from audio or image data if present. Server concatenates these feature vectors and feeds them into an emotion classification model. The model performs matrix multiplications and non-linear activations to produce a probability distribution over emotion classes such as joy, sadness, and surprise. Server selects the emotion with the highest probability, together with its confidence, as emotion information. Server then stores this emotion information in an emotion table linked to the prompt ID. The output of this step is emotion information (emotion label and confidence values) persistently associated with the prompt sentence.

### Step 4:

Server generates generation instruction information for the generative AI model.

Server takes as input the normalized prompt text and the associated emotion information from the database. Server constructs a formatted instruction string by combining the prompt sentence with explicit emotion context. For example, when the detected emotion is surprise, server generates text such as “The user currently feels a sense of surprise. Based on the following prompt, generate an innovative and surprising visual design: [prompt sentence].” Server also retrieves model configuration parameters such as temperature and maximum output length from a configuration store. Server packages the constructed instruction string and parameters into a generation request structure. The output of this step is generation instruction information suitable for direct input to a generative AI model.

### Step 5:

Server invokes the generative AI model and obtains generated content.

Server uses the generation instruction information as input and calls an inference engine hosting a generative AI model. Server tokenizes the instruction text into token IDs according to the model's vocabulary and sends these token IDs, along with generation parameters, to the model. The generative AI model performs forward passes through multiple transformer layers, computing attention scores and updating hidden states to generate a sequence of output tokens or a latent representation, depending on whether the content is text or image. For textual outputs, server receives a sequence of output token IDs and decodes them back to text. For image outputs, server receives an encoded image representation or binary image data. Server returns the raw generated content to the application layer. The output of this step is generated content data corresponding to the prompt sentence and emotion context.

### Step 6:

Server applies content filtering and formatting to the generated content.

Server takes the raw generated content as input and passes it through a content moderation module. Server checks the content against predefined rules and classification thresholds to detect prohibited or inappropriate segments. If the content violates a rule, server redacts, replaces, or discards offending portions. Server then formats the filtered content by inserting paragraph breaks, adding titles, extracting summaries, or generating image metadata such as size and aspect ratio. Server converts the content into a normalized internal format adhering to a predefined schema. Server stores the normalized content into a content store and records a content ID linked to the prompt ID and user ID. The output of this step is normalized and filtered content with a content ID ready for marketplace registration.

### Step 7:

Server structures product information from the normalized content.

Server uses the normalized content record as input and constructs a product data structure that includes a product ID, content ID, prompt ID, user ID (as seller), base price, category, tags, and language. Server may derive some attributes automatically, for example by classifying the content into categories using a lightweight classifier or keyword extraction. Server inserts the product data into a product table in the relational database. Server also generates a document representing the product for a search index and submits it to a search engine, which updates its inverted indices accordingly. The output of this step is product information stored and indexed in the electronic transaction platform.

### Step 8:

Server issues a non-fungible token associated with the product information.

Server takes as input the product record, including product ID and a reference to the content location. Server creates token metadata that includes a URI pointing to the product's content, a description, and an identifier linking back to the product ID and prompt ID. Server constructs a transaction to call a mint function of a smart contract on a distributed ledger network, passing the metadata URI and an owner address. The distributed ledger network executes the contract logic and assigns a unique token ID. Server receives confirmation of the transaction and records the token ID, contract address, and transaction hash in a token table, linked to the product ID. The output of this step is a non-fungible token registered on the distributed ledger and bound to the product information in the server's storage.

### Step 9:

Server prepares product information for browsing and recommendation.

Server takes as input the product table contents, token table contents, emotion information, and behavior history information from the log data store. Server executes a recommendation algorithm that computes a relevance score for each candidate product for a given user by combining collaborative filtering scores, content similarity metrics, and an emotion-based weight derived from the current emotion information. Server also computes or updates dynamic price information by applying pricing rules to each product's base price. Server then selects a subset of products and orders them according to the computed scores. The output of this step is a ranked list of product information, each entry including recommendation order and current price, ready to be sent to a terminal on request.

### Step 10:

Terminal requests and displays product lists and details.

Terminal uses user interaction events as input and sends a browsing or search request to the server, including filters such as keywords, categories, and pagination parameters. Server receives this request and uses its recommendation and search modules to retrieve and order relevant product records, as produced in Step 9, then returns these product records as a response. Terminal receives the response and parses product entries, each containing titles, thumbnails, prices, and NFT presence flags. Terminal renders the products on the display, allowing the user to scroll, select, and open details. The output of this step is a visual representation of candidate products presented to the user on the terminal.

### Step 11:

User initiates a purchase request through the terminal.

User views a particular product on the terminal and decides to purchase it. User interacts with user interface elements such as a “Buy now” button. Terminal collects purchase parameters, including product ID, quantity, and selected payment method, and confirms the total price and fee breakdown with the user. Terminal then constructs a purchase request message containing the product ID, buyer ID, and payment token and transmits this message to the server. The output of this step is a structured purchase request delivered from the terminal to the server for processing.

### Step 12:

Server executes settlement processing and records transaction data.

Server accepts the purchase request as input and validates that the product is available and that pricing information is current. Server sends a payment authorization request to an external settlement processing device, including the charge amount and payment token. The external device returns a result indicating approval or failure. Upon approval, server computes fee information by multiplying the transaction amount by a predefined fee rate and rounding according to configured rules. Server then creates a transaction record containing buyer ID, seller ID, product ID, total amount, computed fee, net amount to seller, and timestamps, and stores this record in a transaction table. The output of this step is persistent transaction data and fee information corresponding to a completed purchase.

### Step 13:

Server updates non-fungible token holder information on the distributed ledger.

Server uses the transaction data and token table records as input to identify the token associated with the purchased product and the wallet addresses of the seller and buyer. If the token is pre-minted, server constructs a transaction that calls a transfer function of the smart contract to transfer the token from the seller address to the buyer address. If the token is minted per purchase, server constructs a minting transaction assigning the token to the buyer address. The distributed ledger network processes the transaction and returns a confirmation.

Server updates the token table with the new holder information and transaction hash. The output of this step is updated holder information on both the distributed ledger and the server's local records.

### Step 14:

Server generates right-to-use information and content acquisition information for the purchaser.

Server takes as input the updated holder information, product ID, and content reference.

Server generates secure access data, such as signed URLs or access tokens, that grant the purchaser rights to access the content. Server also constructs a usage policy descriptor that indicates allowed actions, such as viewing or downloading. Server stores these access data items temporarily or persistently and sends them to the terminal as part of a purchase completion response. The output of this step is right-to-use information and content acquisition information transmitted from the server to the terminal.

### Step 15:

Terminal retrieves and presents purchased content to the user.

Terminal receives the purchase completion response as input, reads the access URLs or tokens, and displays a completion screen including options such as “View content” or “Download design.” When the user selects an option, terminal issues a content retrieval request using the provided URL or token. Server verifies the token and serves the content data. Terminal decodes and renders the content, for example by displaying text, showing an image, or playing audio. The output of this step is the presentation of the purchased generative AI content to the user on the terminal.

### Step 16:

Server aggregates transaction data and generates statistical information.

Server periodically takes transaction records and fee records as input from the transaction table and log data store. Server executes aggregation operations grouped by time period, such as counting transactions, summing amounts, and computing average prices and fees. Server writes these aggregate results to a statistics table that is optimized for query by a management display apparatus. Server may optionally precompute additional metrics such as conversion rates or token transfer volumes. The output of this step is transaction statistical information and fee statistical information stored in a structured format for management use.

### Step 17:

User iterates prompt sentence creation based on system feedback.

User observes, via the terminal, which prompt sentences and corresponding products generate higher engagement and revenue, using management or creator dashboards powered by the statistical information. User then composes new prompt sentences, such as “Generate a story set in a medieval fantasy world where a young wizard rebuilds a lost kingdom” or “Today I want a surprising design,” and inputs them into the terminal. Terminal again sends these new prompt sentences to the server, reentering the processing pipeline beginning with Step 1. The output of this step is a continuous cycle of improved prompt sentences that feed back into the system, leveraging the server's processing flow for further generative AI operations and marketplace transactions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

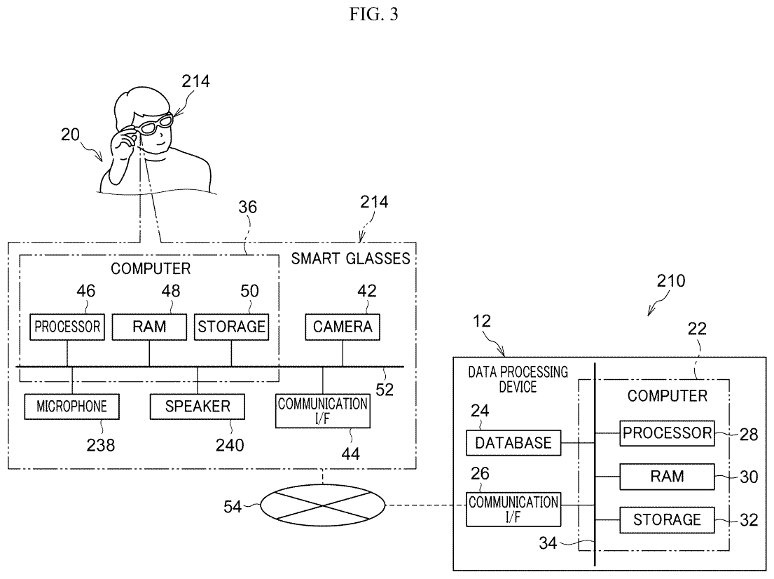

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

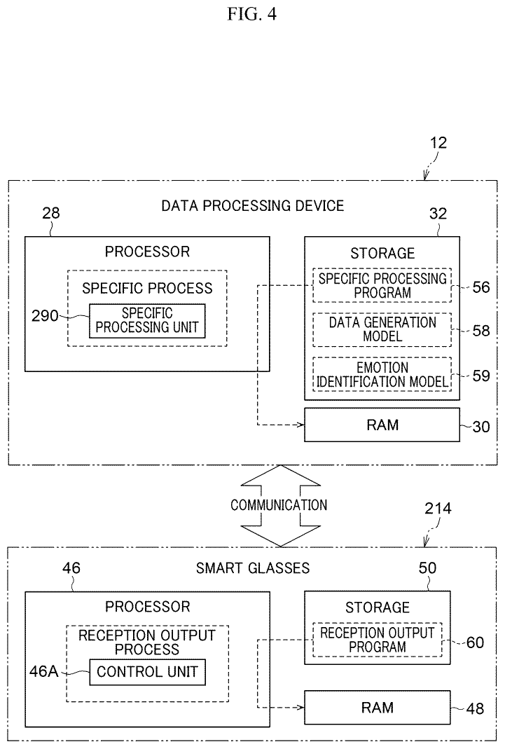

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

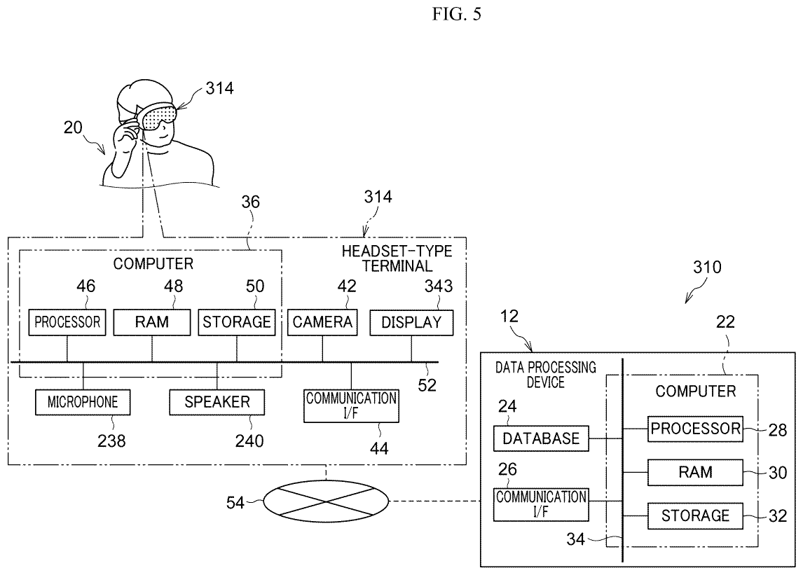

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

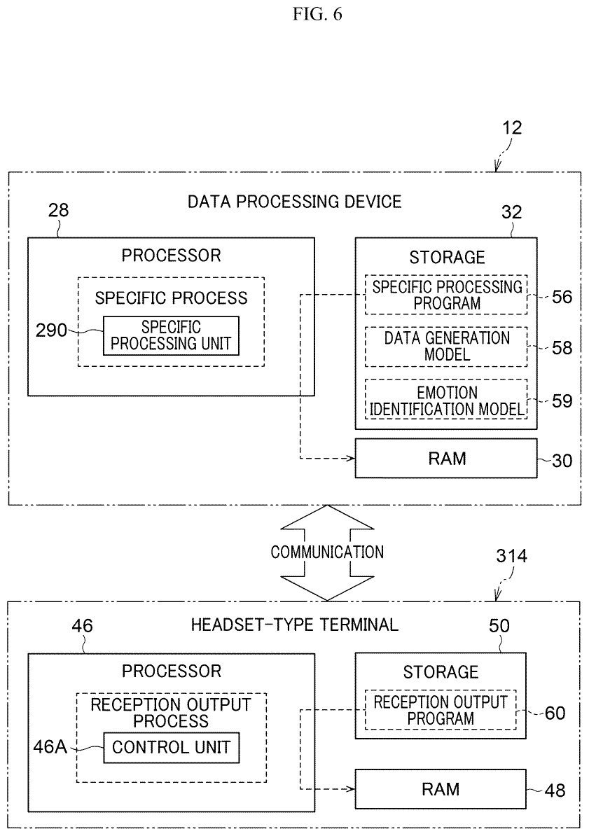

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

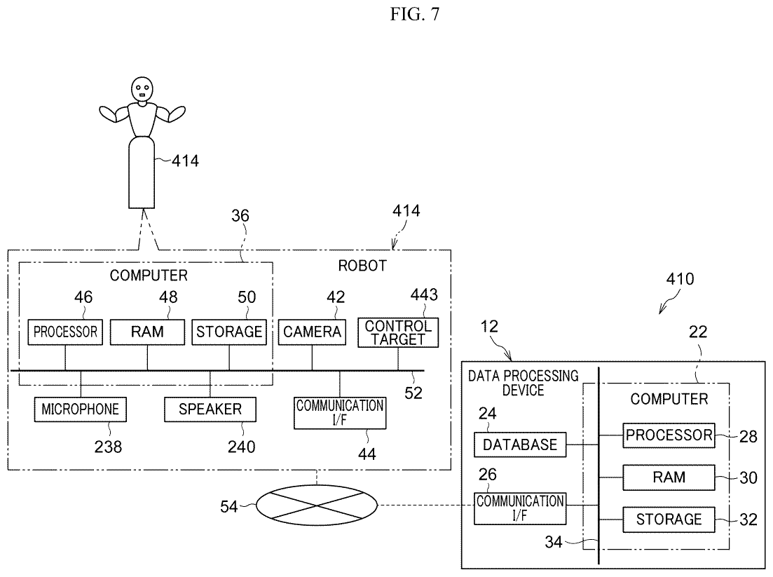

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

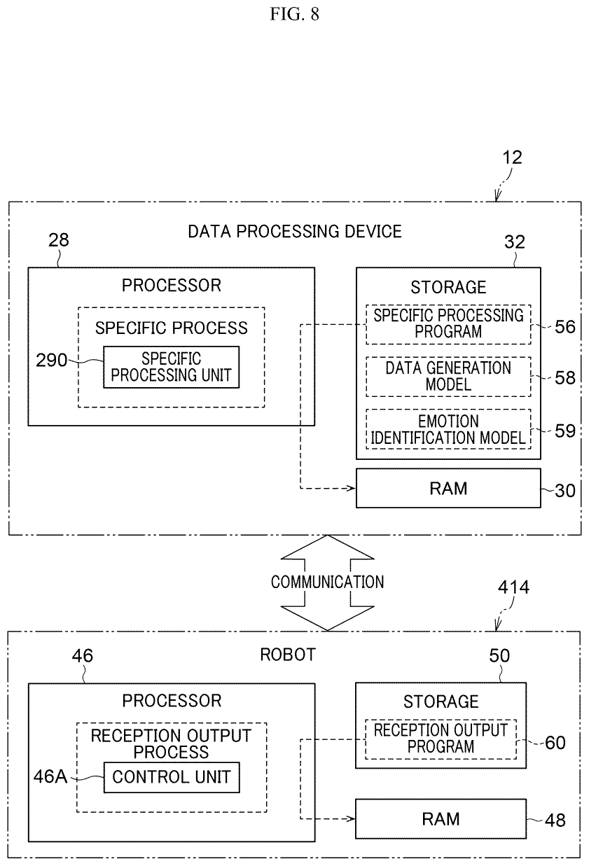

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

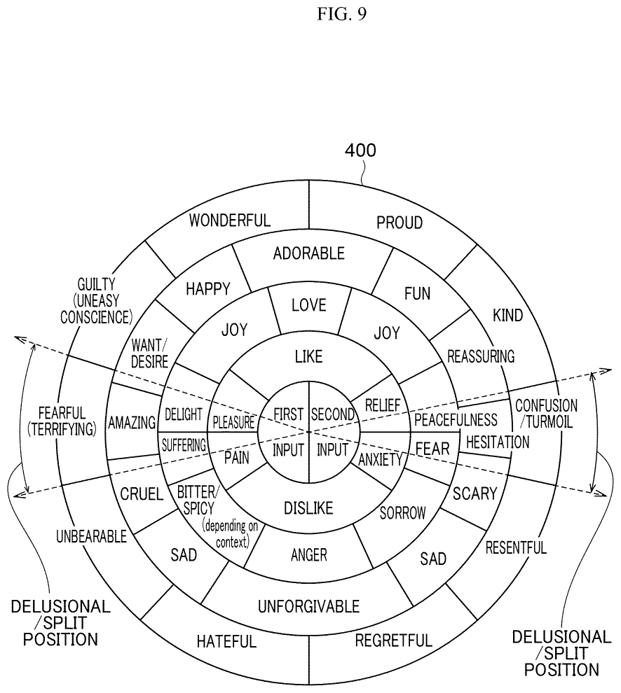

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

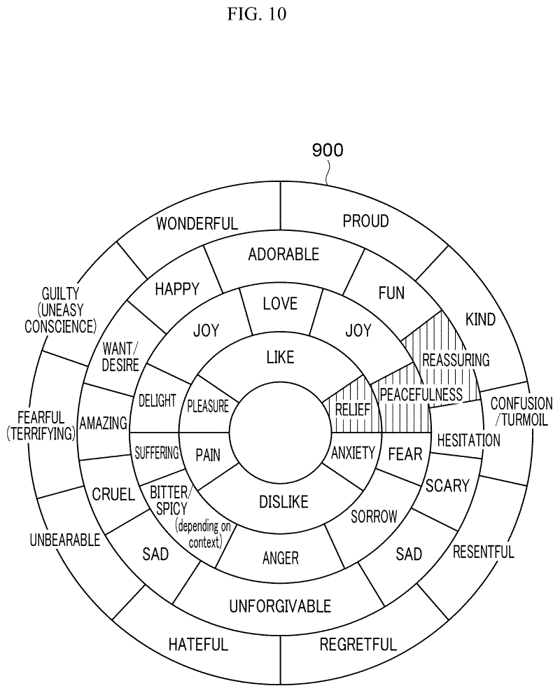

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to receive, via a communication network, a prompt sentence input from a user terminal, and generate generation request data including the prompt sentence and user information,
wherein the processor is configured to convert the prompt sentence included in the generation request data into an input format for a generative AI model by performing tokenization processing and length control processing based on natural language processing,
wherein the processor is configured to execute the generative AI model by using an information processing apparatus and to generate, by computation based on the converted prompt sentence, generation result data including description data of a concept or a design,
wherein the processor is configured to generate, based on the generation result data, sales information including explanation information, attribute information, and price information as structured data, and to register the structured data as listing information of an electronic marketplace,
wherein the processor is configured to generate an issuance transaction of a non-fungible token based on distributed ledger technology in association with the sales information, and to record identification information and owner information of the non-fungible token in association with the listing information,
wherein the processor is configured to transmit, in response to a viewing request from another user terminal in the electronic marketplace, the listing information, the generation result data, and ownership information of the non-fungible token so that the listing information, the generation result data, and the ownership information are displayed on the other user terminal,
wherein the processor is configured to receive purchase and sale requests between users in the electronic marketplace, to establish a purchase and sale transaction in cooperation with a payment processing apparatus, to calculate a fee based on the purchase and sale transaction, and to record the fee as revenue information, and
wherein the processor is configured to execute, in response to establishment of the purchase and sale transaction, an ownership transfer transaction of the non-fungible token by the distributed ledger technology, and to update the listing information and transaction history information based on a result of the ownership transfer.

### Supplementary 2

The system according to Supplementary 1,
wherein the processor is configured to cause the generative AI model to generate a plurality of candidate concepts or designs based on the prompt sentence, and to perform generation of the sales information and issuance processing of the non-fungible token only for a candidate selected based on a selection operation from the user terminal among the plurality of candidate concepts or designs.

### Supplementary 3

The system according to Supplementary 1,
wherein the processor is configured to perform search processing and ranking processing on the listing information and the transaction history information in the electronic marketplace, to generate list information of concepts or designs corresponding to the prompt sentence or search conditions input by a user, and to transmit the list information to a user terminal so that concepts or designs generated by other users are browsable and purchasable.

### Application Example 1

### Supplementary 1

A system comprising a processor,
wherein the processor is configured to
receive, via a communication network, a prompt sentence and user information that are input by a user through a terminal, and
perform authentication processing and content review processing on the received prompt sentence and the user information to generate generation input data, and
input the generation input data into a generative AI model and cause the generative AI model to generate digital content including a concept or a design based on the prompt sentence, and normalize the digital content output from the generative AI model into a predetermined internal format and store the digital content as information distribution platform content data by assigning an identifier, user identification information, and attribute information to the digital content, and
generate, on a distributed ledger system, a non-fungible token corresponding to the information distribution platform content data and register ownership information by associating the non-fungible token with the information distribution platform content data, and
publish the information distribution platform content data, for which the ownership information is registered, as a saleable asset in an electronic marketplace and, in response to a viewing request, distribute information related to the saleable asset to another terminal, and accept, in the electronic marketplace, a purchase request for the saleable asset, execute settlement processing and rights transfer processing of the non-fungible token, and generate transaction data, and
record transaction history information and fee information based on the transaction data and manage the fee information as revenue information.

### Supplementary 2

The system according to supplementary 1,
wherein the processor is configured to analyze the received prompt sentence using a natural language processing technique, generate control parameters, classification information, or additional instruction information for the generative AI model, and input the control parameters, the classification information, or the additional instruction information into the generative AI model as at least part of the generation input data to control content or format of the digital content generated by the generative AI model.

### Supplementary 3

The system according to supplementary 1,
wherein the processor is configured to
manage, for each saleable asset in the electronic marketplace, price information, transaction condition information, and publication state information, update the price information, the transaction condition information, and the publication state information in response to an editing operation performed by the user through the terminal, and change a publication range and a sale state of the information distribution platform content data based on the updated information.

### Example 2

### Supplementary 1

A system comprising a processor,
wherein the processor is configured to
receive, via a communication function, a prompt sentence and user identification information transmitted from a terminal, and store the prompt sentence and the user identification information in a storage device,
analyze the prompt sentence by using a natural language processing function to generate input data for a generative artificial intelligence model, and supply the input data to the generative artificial intelligence model so as to cause the generative artificial intelligence model to generate concept information or design information,
convert output of the generative artificial intelligence model into image data or character string data, store the converted data in an external storage device, and generate identification information for identifying a storage location in the external storage device,
register, in an electronic marketplace database that manages the concept information or the design information as transaction target information, the identification information in association with the user identification information and transaction condition information,
generate, for each item of the transaction target information, a unique identifier by using a cryptographic method and record, in a distributed ledger or in an internal management ledger, a correspondence between the unique identifier and the transaction target information so as to assign non-fungible token information,
receive search conditions from the terminal, search the electronic marketplace database based on the search conditions to generate a list of the transaction target information, and transmit display data of the list to the terminal,
receive a purchase request and settlement information from the terminal, execute settlement processing of a transaction amount by using a settlement processing function, calculate a transaction fee based on the transaction amount and record the transaction fee as revenue information, update a rights state or a license state of the transaction target information, and update owner information or usage right information of the non-fungible token information, receive evaluation information from the terminal after completion of a transaction corresponding to the purchase request, record the evaluation information in the electronic marketplace database, and update reliability information for each user based on the evaluation information, and
control a search result or a display order based on the transaction target information or the reliability information for each user, and provide the controlled search result or display order to the terminal.

### Supplementary 2

The system according to supplementary 1,
wherein the processor is configured to record the prompt sentence and the concept information or the design information as history information, and to perform control to improve generation accuracy or diversity of the concept information or the design information by generating, from the history information, an input parameter or prompt assistance information for the generative artificial intelligence model.

### Supplementary 3

The system according to supplementary 1,
wherein the processor is configured to analyze the evaluation information and transaction fee information to generate a feature quantity for fraudulent transaction detection, to determine a user or a transaction suspected of being fraudulent by using statistical analysis processing or machine learning processing based on the feature quantity, and to execute display restriction processing or transaction restriction processing in the electronic marketplace based on a result of the determination.

### Application Example 2

### Supplementary 1

A system comprising a processor,
wherein the processor is configured to receive, from a terminal operated by a user, a prompt sentence input by the user, estimate emotion information based on the prompt sentence and attribute information related to the user, and store the emotion information in association with the prompt sentence, generate generation instruction information by expanding the prompt sentence based on the emotion information, and input the generation instruction information to a generative AI model,
obtain concept information or design information generated by the generative AI model based on the generation instruction information, and perform content filtering processing and formatting processing on the concept information or the design information,
structure the concept information or the design information as product information, register the product information in an information storage device of an electronic transaction platform, and update a search index for the product information,
generate non-substitutable identification information corresponding to the product information by calling a smart contract on a distributed ledger network, issue a non-fungible token for identifying the product information, and store an identifier of the non-fungible token in association with the product information,
extract the product information in response to a browsing request or a search request from another user, determine at least one of a recommendation order and price information dynamically based on the emotion information and behavior history information of a user, and transmit information including the determined at least one of the recommendation order and the price information to the terminal,
receive a purchase request from the other user, execute settlement processing by using an external settlement processing device, generate transaction data based on a result of the settlement processing, calculate fee information based on the transaction data, and store the transaction data and the fee information, and
update holder information of the non-fungible token on the distributed ledger network based on the transaction data, and provide, to the terminal, right-to-use information and content acquisition information for a purchaser based on the updated holder information.

### Supplementary 2

The system according to supplementary 1,
wherein the processor is configured to
estimate the emotion information by using an emotion analysis model based on at least one of text information, audio information, image information, and behavior history information acquired from the user, and attach the estimated emotion information to a prompt sentence to be input to the generative AI model so that the concept information or the design information is generated in accordance with the emotion information.

### Supplementary 3

The system according to supplementary 1,
wherein the processor is configured to
aggregate the transaction data to generate transaction statistical information and fee statistical information for each period, and store the statistical information in a format outputtable to a management display apparatus.

What is claimed is:

1. A system comprising:
circuitry configured to:
receive, via a communication interface coupled to a packet-switched network, input data comprising a natural-language expression from a terminal device;
transmit model input data derived from the input data to a generative model to cause the generative model to generate output content data based on the natural-language expression;
register the output content data in a data storage unit of a digital transaction platform and generate a search index entry associated with the output content data;
generate, using a cryptographic method, a unique identifier corresponding to the output content data and record, in a ledger data structure, a correspondence between the unique identifier and the output content data; and
transmit, to the terminal device via the communication interface, display data representing the registered output content data and the unique identifier.

2. The system according to claim 1, wherein the circuitry is configured to:
receive, from a second terminal device, a transaction request referencing the output content data,
execute settlement processing of a transaction amount using a settlement processing unit,
calculate a fee based on the transaction amount and store the fee as revenue data, and
update ownership information associated with the unique identifier in the ledger data structure based on a result of the settlement processing.

3. The system according to claim 2, wherein the circuitry is configured to:
receive evaluation data from the second terminal device after completion of the transaction,
store the evaluation data in the data storage unit in association with user identification information, and
update reliability information for each user based on the evaluation data.

4. The system according to claim 3, wherein the circuitry is configured to:
adjust at least one of a search result ranking or a display order of registered output content data based on the reliability information.

5. The system according to claim 1, wherein the circuitry is configured to:
analyze the input data using natural language processing to extract semantic features, and
generate instruction data based on the extracted semantic features to direct the generative model to produce the output content data.

6. The system according to claim 5, wherein the circuitry is configured to:
store the input data and the output content data as history data in the data storage unit, and
generate, from the history data, a prompt assistance parameter for improving generation accuracy or diversity of subsequent output content data.

7. The system according to claim 1, wherein the ledger data structure comprises a distributed ledger, and the unique identifier comprises a non-fungible token recorded on the distributed ledger via a smart contract invocation.

8. The system according to claim 7, wherein the circuitry is configured to:
update holder information of the non-fungible token on the distributed ledger based on transaction data, and
provide right-to-use information and content acquisition information to a purchaser terminal device based on the updated holder information.

9. The system according to claim 1, wherein the output content data comprises at least one of concept data representing an abstract or concrete plan, or design data representing an appearance, structure, or layout.

10. The system according to claim 1, wherein the circuitry is configured to:
perform content filtering processing and formatting processing on the output content data before registering the output content data in the data storage unit.

11. The system according to claim 1, wherein the circuitry is configured to:
receive search condition data from the terminal device,
search the data storage unit based on the search condition data to generate a list of registered content items, and
transmit display data of the list to the terminal device via the communication interface.

12. The system according to claim 1, wherein the circuitry is configured to:
estimate emotion information based on the input data and attribute information associated with a user, and
expand the model input data based on the emotion information before transmitting the model input data to the generative model.

13. The system according to claim 12, wherein the circuitry is configured to:
determine at least one of a recommendation order or price information dynamically based on the emotion information and behavior history information of a user.

14. The system according to claim 1, wherein the circuitry is configured to:
analyze evaluation data and fee data to generate a feature quantity for anomalous transaction detection, and
execute at least one of display restriction processing or transaction restriction processing based on a result of the anomalous transaction detection.

15. The system according to claim 1, wherein the circuitry is configured to:
aggregate transaction data to generate statistical information for each period, and
store the statistical information in a format outputtable to a management display apparatus.

16. The system according to claim 1, wherein the terminal device comprises at least one of a mobile computing device, a wearable display device, a headset-type terminal, or a robotic apparatus, each coupled to the packet-switched network via the communication interface.

17. The system according to claim 16, wherein the terminal device comprises the wearable display device including a microphone and a speaker, and the circuitry is configured to:
receive audio data representing user speech from the wearable display device, and
transmit audio output data to the speaker of the wearable display device.

18. The system according to claim 1, wherein:
the circuitry comprises a processor, a memory storing a program, a communication interface, and a storage device,
the processor executes the program to implement the generation of the unique identifier and the registration of the output content data,
the storage device stores the output content data, the unique identifier, and transaction data, and
the communication interface exchanges data with the terminal device over the packet-switched network.

19. The system according to claim 18, wherein the storage device comprises a transaction database that associates content identifiers with user identification information, transaction condition information, and fee records.

20. A method performed by circuitry, the method comprising:
receiving, via a communication interface coupled to a packet-switched network, input data comprising a natural-language expression from a terminal device;
transmitting model input data derived from the input data to a generative model to cause the generative model to generate output content data based on the natural-language expression;
registering the output content data in a data storage unit of a digital transaction platform and generating a search index entry associated with the output content data;
generating, using a cryptographic method, a unique identifier corresponding to the output content data and recording, in a ledger data structure, a correspondence between the unique identifier and the output content data; and
transmitting, to the terminal device via the communication interface, display data representing the registered output content data and the unique identifier.
